(19) United States
(12) Patent Application Publication
(10) Pub. No.: US 2015/0003531 A1
(43) Pub. Date: Jan. 1, 2015

(54) IMAGE PROCESSING DEVICE AND METHOD

(71) Applicant: Sony Corporation, Tokyo (JP)

(72) Inventor: Kazushi Sato, Kanagawa (JP)

(73) Assignee: SONY CORPORATION, Tokyo (JP)

(21) Appl. No.: 14/352,066

(22) PCT Filed: Nov. 28, 2012
(86) PCT No.: PCT/JP2012/080794

§ 371 Date: Apr. 16, 2014

(30) Foreign Application Priority Data
Dec. 6, 2011 (JP) 2011-267357

(51) Int. Cl. H04N 19/51; H04N 19/615

(52) U.S. Cl. CPC H04N 19/00696; H04N 19/00684; H04N 19/00787
USPC 375/240.16

(57) ABSTRACT

The present disclosure relates to image processing devices and methods that can increase encoding efficiency in encoding or decoding motion vectors in cases where an input is an interlaced signal. The current PU and the reference PU to be referenced by the motion vector information about the current PU belong to top fields. Meanwhile, a Co-located PU belongs to a top field, and the reference PU to be referenced by the motion vector information about the Co-located PU belongs to a bottom field. Therefore, there is phase shifting between the fields. In view of this, a parity adjustment unit performs −½ shift adjustment on the vertical component of the motion vector information about the Co-located PU as indicated by the arrow with a dashed line. The present disclosure can be applied to image processing devices, for example.

### TECHNICAL FIELD

The present disclosure relates to image processing devices and methods, and more particularly, to image processing devices and methods that can increase encoding efficiency in encoding or decoding motion vectors in cases where inputs are interlaced signals.

### BACKGROUND ART

In recent years, apparatuses that compress images by implementing an encoding method for compressing image information through orthogonal transforms such as discrete cosine transforms and motion compensation by using redundancy inherent to image information, have been spreading so as to handle image information as digital information and achieve high-efficiency information transmission and accumulation in doing do. This encoding method may be MPEG (Moving Picture Experts Group), for example.

Particularly, MPEG2 (ISO/IEC 13818-2) is defined as a general-purpose image encoding standard, and is applicable to interlaced images and non-interlaced images, and to standard-resolution images and high-definition images. MPEG2 is currently used in a wide range of applications for professionals and general consumers, for example. By using the MPEG2 compression method, a bit rate of 4 to 8 Mbps is assigned to a standard-resolution interlaced image having 720×480 pixels, for example. Also, by using the MPEG2 compression method, a bit rate of 18 to 22 Mbps is assigned to a high-resolution interlaced image having 1920×1088 pixels, for example. In this manner, a high compression rate and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

On the standardization schedule, the standard was approved as an international standard under the name of H.264 and MPEG-4 Part 10 (Advanced Video Coding, hereinafter referred to as AVC) in March 2003.

As an extension of AVC, FRExt (Fidelity Range Extension) was standardized in February 2005. FRExt includes coding tools for business use, such as RGB, 4:2:2, and 4:4:4, and the 8×8 DCT and quantization matrix specified in MPEG-2. As a result, an encoding method for enabling excellent presentation of movies containing film noise was realized by using AVC, and the encoding method is now used in a wide range of applications such as Blu-ray Disc (a trade name).

However, there is an increasing demand for encoding at a higher compression rate so as to compress images having a resolution of about 4000×2000 pixels, which is four times higher than the high-definition image resolution, or distribute high-definition images in today's circumstances where transmission capacities are limited as in the Internet. Therefore, studies on improvement in encoding efficiency is still continued by VCEG (Video Coding Expert Group) under ITU-T.

As one of the encoding efficiency improvement measures to improve the motion vector encoding using median predictions according to AVC, there has been a suggested technique (hereinafter also referred to as “MV competition”) adaptively using “Temporal Predictor” or “Spatio-Temporal Predictor” as predicted motion vector information in addition to “Spatial Predictor”, which is defined in AVC and is determined through a median prediction (see Non-Patent Document 1, for example).

According to AVC, when predicted motion vector information is selected, cost function values calculated in High Complexity Mode or Low Complexity Mode, which is programmed in the AVC-compliant reference software called JM (Joint Model), are used.

Specifically, cost function values are calculated by using predicted motion vector information, and the optimum predicted motion vector information is selected. Through the compressed image information, flag information indicating the information as to which predicted motion vector information has been used is transmitted for each block.

Meanwhile, the macroblock size of 16×16 pixels might not be optimal for a large frame such as an UHD (Ultra High Definition: 4000×2000 pixels) frame to be encoded by a next-generation encoding method.

In view of this and for the purpose of achieving an even higher encoding efficiency than that achieved by AVC, an encoding method called HEVC (High Efficiency Video Coding) is now being standardized by JCTVC (Joint Collaboration Team-Video Coding), which is a joint standards organization of ITU-T and ISO/IEC (see Non-Patent Document 2, for example).

According to HEVC, Coding Units (CUs) are defined as units of processing like macroblocks of AVC. Unlike the macroblocks of AVC, the CUs are not fixed to the size of 16×16 pixels. The size of the CUs is specified in the compressed image information in each sequence. In each sequence, the largest size of the CUs (LCU=Largest Coding Unit) and the smallest size (SCU=Smallest Coding Unit) are also specified.

As one of the motion information encoding methods, a technique called Motion Partition Merging (hereinafter also referred to as the merge mode (Merge Mode)) has also been suggested (see Non-Patent Document 3, for example). By this technique, when the motion information about the current block is the same as the motion information about an adjacent block, only flag information is transmitted, and, at the time of decoding, the motion information about the current block is reconstructed by using the motion information about the adjacent block.

That is, in Merge Mode, a Spatial Predictor (a spatially-predicted motion vector) and a Temporal Predictor (a temporally-predicted motion vector) are also determined from an adjacent block, and the optimum predicted motion vector is selected from those motion vectors. In Merge Mode, only the flag information is transmitted when the determined predicted motion vector is the same as the motion information about the current block.

According to AVC, when an image to be input is an interlaced signal, frame encoding or field encoding can be selected for each picture or each macroblock pair. In an interlaced signal, a frame or each macroblock is formed alternately with top fields and bottom fields that have different parities (top and bottom).

Field encoding is a method of performing encoding on each field formed with top fields and bottom fields, and frame encoding is a method of performing encoding on the top fields and the bottom fields, which are not separated by parity.

### CITATION LIST

### Non-Patent Documents

Non-Patent Document 1: Joel Jung, Guillaume Laroche, “Competition-Based Scheme for Motion Vector Selection and Coding”, VCEG-AC06, ITU-Telecommunications Standardization SectorSTUDY GROUP 16 Question 6Video Coding Experts Group (VCEG) 29th Meeting: Klagenfurt, Austria, 17-18 Jul., 2006
Non-Patent Document 2: Thomas Wiegand, Woo-Jin Han, Benjamin Bross, Jens-Rainer Ohm, Gary J. Sullivan, “Working Draft 4 of High-Efficiency Video Coding”, JCTVC-F803, Joint Collaborative Team on Video Coding (JCT-VC) of ITU-T SG16 WP3 and ISO/IEC JTC1/SC29/WG11 6th Meeting: Torino, IT, 14-22 Jul., 2011
Non-Patent Document 3: Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suehring, and Thomas Wiegand, “Description of video coding technology proposed by Fraunhofer HHI”, JCTVC-A116, April, 2010

### SUMMARY OF THE INVENTION

### Problems to be Solved by the Invention

The above described functions for interlaced signals might be applied to HEVC. However, when a temporally-predicted motion vector generated through the above described MV Competition or in Merge Mode is applied to an input of an interlaced signal, the temporally-predicted motion vector is generated between different parities in some cases.

Since there is phase shifting in the vertical direction between different parities, encoding efficiency might become lower when a temporally-predicted motion vector is generated between different parities.

The present disclosure is made in view of those circumstances, and aims to increase encoding efficiency in encoding or decoding motion vectors in cases where an input is an interlaced signal.

### Solutions to Problems

An image processing device of one aspect of the present disclosure includes: a predicted motion vector generation unit that generates the temporally-predicted motion vector of the predicted motion vectors to be used in decoding the motion vector of the current region in an image of an interlaced signal, by using the motion vector of a temporally-adjacent region that is located temporally adjacent to the current region; a parity adjustment unit that performs shift adjustment on the vertical component of the temporally-predicted motion vector generated by the predicted motion vector generation unit, in accordance with the parity relation between the current region and the current reference region to be referenced by the motion vector of the current region, and the parity relation between the temporally-adjacent region and the adjacent reference region to be referenced by the motion vector of the temporally-adjacent region; and a motion vector decoding unit that decodes the motion vector of the current region by using the temporally-predicted motion vector having the vertical component subjected to the shift adjustment by the parity adjustment unit.

When the phase shifting indicated by the parity relation between the current region and the current reference region differs from the phase shifting indicated by the parity relation between the temporally-adjacent region and the adjacent reference region, the parity adjustment unit can perform shift adjustment on the vertical component of the temporally-predicted motion vector generated by the predicted motion vector generation unit.

When the phase shifting indicated by the parity relation between the current region and the current reference region is the opposite of the phase shifting indicated by the parity relation between the temporally-adjacent region and the adjacent reference region, the parity adjustment unit can perform 1 or −1 shift adjustment on the vertical component of the temporally-predicted motion vector generated by the predicted motion vector generation unit.

When the parity relation between the current region and the current reference region is “BT” while the parity relation between the temporally-adjacent region and the adjacent reference region is “TB”, the parity adjustment unit can perform 1 shift adjustment on the vertical component of the temporally-predicted motion vector generated by the predicted motion vector generation unit.

When only one of the parity relation between the current region and the current reference region, and the parity relation between the temporally-adjacent region and the adjacent reference region indicates phase shifting, and the other one of the parity relations indicates no phase shifting, the parity adjustment unit can perform ½ or −½ shift adjustment on the vertical component of the temporally-predicted motion vector generated by the predicted motion vector generation unit.

When the parity relation between the current region and the current reference region is “TT” while the parity relation between the temporally-adjacent region and the adjacent reference region is “BT”, the parity adjustment unit can perform ½ shift adjustment on the vertical component of the temporally-predicted motion vector generated by the predicted motion vector generation unit.

The motion vector decoding unit can decode the motion vector of the current region by using the temporally-predicted motion vector having the vertical component subjected to the shift adjustment by the parity adjustment unit based on Advanced Motion Vector Prediction.

The motion vector decoding unit can decode the motion vector of the current region by using the temporally-predicted motion vector having the vertical component subjected to the shift adjustment by the parity adjustment unit based on Motion Partition Merging.

An image processing method of one aspect of the present disclosure includes: generating the temporally-predicted motion vector of the predicted motion vectors to be used in decoding the motion vector of the current region in an image of an interlaced signal, by using the motion vector of a temporally-adjacent region that is located temporally adjacent to the current region; performing shift adjustment on the vertical component of the generated temporally-predicted motion vector, in accordance with the parity relation between the current region and the current reference region to be referenced by the motion vector of the current region, and the parity relation between the temporally-adjacent region and the adjacent reference region to be referenced by the motion vector of the temporally-adjacent region; and decoding the motion vector of the current region by using the temporally-predicted motion vector having the vertical component subjected to the shift adjustment, an image processing device generating the temporally-predicted motion vector, performing the shift adjustment, and decoding the motion vector of the current region.

An image processing device of another aspect of the present disclosure includes: a predicted motion vector generation unit that generates the temporally-predicted motion vector of the predicted motion vectors to be used in encoding the motion vector of the current region in an image of an interlaced signal, by using the motion vector of a temporally-adjacent region that is located temporally adjacent to the current region; a parity adjustment unit that performs shift adjustment on the vertical component of the temporally-predicted motion vector generated by the predicted motion vector generation unit, in accordance with the parity relation between the current region and the current reference region to be referenced by the motion vector of the current region, and the parity relation between the temporally-adjacent region and the adjacent reference region to be referenced by the motion vector of the temporally-adjacent region; and a motion vector encoding unit that encodes the motion vector of the current region by using the temporally-predicted motion vector having the vertical component subjected to the shift adjustment by the parity adjustment unit.

When the phase shifting indicated by the parity relation between the current region and the current reference region differs from the phase shifting indicated by the parity relation between the temporally-adjacent region and the adjacent reference region, the parity adjustment unit can perform shift adjustment on the vertical component of the temporally-predicted motion vector generated by the predicted motion vector generation unit.

When the phase shifting indicated by the parity relation between the current region and the current reference region is the opposite of the phase shifting indicated by the parity relation between the temporally-adjacent region and the adjacent reference region, the parity adjustment unit can perform 1 or −1 shift adjustment on the vertical component of the temporally-predicted motion vector generated by the predicted motion vector generation unit.

When the parity relation between the current region and the current reference region is “BT” while the parity relation between the temporally-adjacent region and the adjacent reference region is “TB”, the parity adjustment unit can perform 1 shift adjustment on the vertical component of the temporally-predicted motion vector generated by the predicted motion vector generation unit.

When only one of the parity relation between the current region and the current reference region, and the parity relation between the temporally-adjacent region and the adjacent reference region indicates phase shifting, and the other one of the parity relations indicates no phase shifting, the parity adjustment unit can perform ½ or −½ shift adjustment on the vertical component of the temporally-predicted motion vector generated by the predicted motion vector generation unit.

When the parity relation between the current region and the current reference region is “TT” while the parity relation between the temporally-adjacent region and the adjacent reference region is “BT”, the parity adjustment unit can perform ½ shift adjustment on the vertical component of the temporally-predicted motion vector generated by the predicted motion vector generation unit.

The motion vector encoding unit can encode the motion vector of the current region by using the temporally-predicted motion vector having the vertical component subjected to the shift adjustment by the parity adjustment unit based on Advanced Motion Vector Prediction.

The motion vector encoding unit can encode the motion vector of the current region by using the temporally-predicted motion vector having the vertical component subjected to the shift adjustment by the parity adjustment unit based on Motion Partition Merging.

An image processing method of another aspect of the present disclosure includes: generating the temporally-predicted motion vector of the predicted motion vectors to be used in encoding the motion vector of the current region in an image of an interlaced signal, by using the motion vector of a temporally-adjacent region that is located temporally adjacent to the current region; performing shift adjustment on the vertical component of the generated temporally-predicted motion vector, in accordance with the parity relation between the current region and the current reference region to be referenced by the motion vector of the current region, and the parity relation between the temporally-adjacent region and the adjacent reference region to be referenced by the motion vector of the temporally-adjacent region; and encoding the motion vector of the current region by using the temporally-predicted motion vector having the vertical component subjected to the shift adjustment, an image processing device generating the temporally-predicted motion vector, performing the shift adjustment, and encoding the motion vector of the current region.

In one aspect of the present disclosure, the temporally-predicted motion vector of the predicted motion vectors to be used in decoding the motion vector of the current region in an image of an interlaced signal is generated by using the motion vector of a temporally-adjacent region that is located temporally adjacent to the current region. Shift adjustment is performed on the vertical component of the generated temporally-predicted motion vector in accordance with the parity relation between the current region and the current reference region to be referenced by the motion vector of the current region, and the parity relation between the temporally-adjacent region and the adjacent reference region to be referenced by the motion vector of the temporally-adjacent region. The motion vector of the current region is then decoded by using the temporally-predicted motion vector having the vertical component subjected to the shift adjustment.

In another aspect of the present disclosure, the temporally-predicted motion vector of the predicted motion vectors to be used in encoding the motion vector of the current region in an image of an interlaced signal is generated by using the motion vector of a temporally-adjacent region that is located temporally adjacent to the current region. Shift adjustment is performed on the vertical component of the generated temporally-predicted motion vector in accordance with the parity relation between the current region and the current reference region to be referenced by the motion vector of the current region, and the parity relation between the temporally-adjacent region and the adjacent reference region to be referenced by the motion vector of the temporally-adjacent region. The motion vector of the current region is then encoded by using the temporally-predicted motion vector having the vertical component subjected to the shift adjustment.

Each of the above described image processing devices may be an independent device, or may be an internal block forming an image encoding device or an image decoding device.

### Effects of the Invention

According to one aspect of the present disclosure, images can be decoded. Particularly, encoding efficiency can be increased in encoding or decoding motion vectors in cases where inputs are interlaced signals.

According to another aspect of the present disclosure, images can be encoded. Particularly, encoding efficiency can be increased in encoding or decoding motion vectors in cases where inputs are interlaced signals.

### BRIEF DESCRIPTION OF DRAWINGS

FIG. 1 is a block diagram showing a typical example structure of an image encoding device.

FIG. 2 is a diagram showing an example motion prediction/compensation process with decimal pixel precision.

FIG. 3 is a diagram showing example macroblocks.

FIG. 4 is a diagram for explaining a median operation.

FIG. 5 is a diagram for explaining a Multi-Reference Frame.

FIG. 6 is a diagram for explaining Temporal Direct Mode.

FIG. 7 is a diagram for explaining a motion vector encoding method.

FIG. 8 is a diagram for explaining example structures of Coding Units.

FIG. 9 is a diagram for explaining Motion Partition Merging.

FIG. 10 is a diagram showing an example of interlaced signal encoding on a picture basis.

FIG. 11 is a diagram showing an example of interlaced signal encoding on a macroblock pair basis.

FIG. 12 is a diagram showing an example of a parity adjustment method according to the present technique.

FIG. 13 is a diagram showing another example of a parity adjustment method according to the present technique.

FIG. 14 is a diagram showing yet another example of a parity adjustment method according to the present technique.

FIG. 15 is a diagram showing all the examples of parity adjustment methods.

FIG. 16 is a block diagram showing typical example structures of the motion vector encoding unit and the parity adjustment unit.

FIG. 17 is a flowchart for explaining an example flow of an encoding process.

FIG. 18 is a flowchart for explaining an example flow of the inter motion prediction process.

FIG. 19 is a flowchart for explaining an example flow of the predicted motion vector generation process.

FIG. 20 is a block diagram showing a typical example structure of an image decoding device.

FIG. 21 is a block diagram showing typical example structures of the motion vector decoding unit and the parity adjustment unit.

FIG. 22 is a flowchart for explaining an example flow of a decoding process.

FIG. 23 is a flowchart for explaining an example flow of a motion vector reconstruction process.

FIG. 24 is a diagram for explaining an application of the present technique to a multi-view image.

FIG. 25 is a block diagram showing a typical example structure of a computer.

FIG. 26 is a block diagram schematically showing an example structure of a television apparatus.

FIG. 27 is a block diagram schematically showing an example structure of a portable telephone device.

FIG. 28 is a block diagram schematically showing an example structure of a recording/reproducing apparatus.

FIG. 29 is a block diagram schematically showing an example structure of an imaging apparatus.

### MODES FOR CARRYING OUT THE INVENTION

Modes for carrying out the present disclosure (hereinafter referred to as the embodiments) will be described below. Explanation will be made in the following order.

### 1. First Embodiment (Image Encoding Device)

### 2. Second Embodiment (Image Decoding Device)

### 3. Third Embodiment (Computer)

### 4. Example Applications

### 1. First Embodiment

### Image Encoding Device

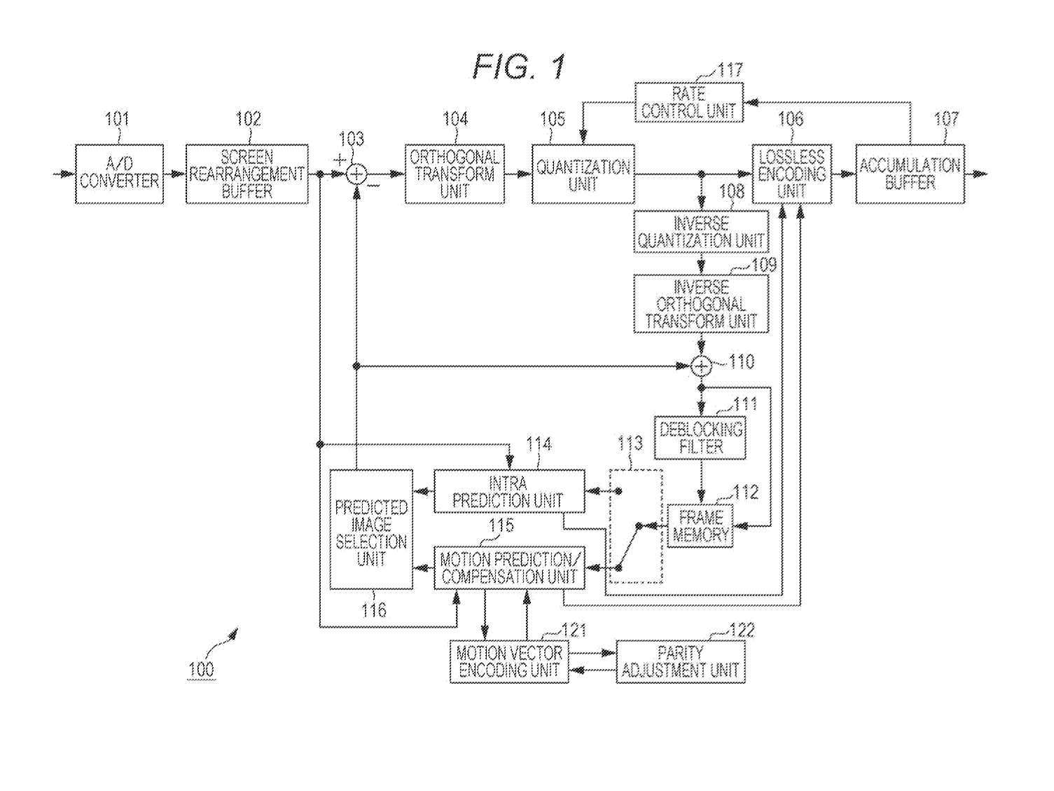

FIG. 1 is a block diagram showing a typical example structure of an image encoding device.

The image encoding device 100 shown in FIG. 1 encodes image data by using prediction processes according to HEVC (High Efficiency Video Coding), for example.

As shown in FIG. 1, the image encoding device 100 includes an A/D converter 101, a screen rearrangement buffer 102, an arithmetic operation unit 103, an orthogonal transform unit 104, a quantization unit 105, a lossless encoding unit 106, an accumulation buffer 107, an inverse quantization unit 108, and an inverse orthogonal transform unit 109. The image encoding device 100 also includes an arithmetic operation unit 110, a deblocking filter 111, a frame memory 112, a selection unit 113, an intra prediction unit 114, a motion prediction/compensation unit 115, a predicted image selection unit 116, and a rate control unit 117.

The image encoding device 100 further includes a motion vector encoding unit 121 and a parity adjustment unit 122.

The A/D converter 101 subjects input image data to an A/D conversion, and supplies and stores the converted image data (digital data) into the screen rearrangement buffer 102. The screen rearrangement buffer 102 rearranges the image having frames stored in displaying order in accordance with the GOP (Group of Pictures) structure, so that the frames are arranged in frame order for encoding. The image having the frames rearranged is supplied to the arithmetic operation unit 103. The screen rearrangement buffer 102 also supplies the image having the rearranged frame order to the intra prediction unit 114 and the motion prediction/compensation unit 115.

The arithmetic operation unit 103 subtracts a predicted image supplied from the intra prediction unit 114 or the motion prediction/compensation unit 115 via the predicted image selection unit 116, from the image read from the screen rearrangement buffer 102, and outputs the difference information to the orthogonal transform unit 104.

When inter encoding is performed on an image, for example, the arithmetic operation unit 103 subtracts a predicted image supplied from the motion prediction/compensation unit 115, from the image read from the screen rearrangement buffer 102.

The orthogonal transform unit 104 performs an orthogonal transform, such as a discrete cosine transform or a Karhunen-Loeve transform, on the difference information supplied from the arithmetic operation unit 103. This orthogonal transform is performed by any appropriate method. The orthogonal transform unit 104 supplies the transform coefficient to the quantization unit 105.

The quantization unit 105 quantizes the transform coefficient supplied from the orthogonal transform unit 104. Based on target bit rate information supplied from the rate control unit 117, the quantization unit 105 sets a quantization parameter, and performs quantization. This quantization is performed by any appropriate method. The quantization unit 105 supplies the quantized transform coefficient to the lossless encoding unit 106.

The lossless encoding unit 106 encodes the transform coefficient quantized by the quantization unit 105 by an appropriate encoding method. Since the coefficient data has already been quantized under the control of the rate control unit 117, the bit rate becomes equal to the target value (or approximates the target value) that is set by the rate control unit 117.

The lossless encoding unit 106 also acquires information indicating an intra prediction mode and the like from the intra prediction unit 114, and acquires information indicating an inter prediction mode, difference motion vector information, and the like from the motion prediction/compensation unit 115.

The lossless encoding unit 106 encodes those various kinds of information by an appropriate encoding method, and incorporates the information into (or multiplexes the information with) the header information of encoded data (also referred to as an encoded stream). The lossless encoding unit 106 supplies and stores the encoded data obtained through the encoding into the accumulation buffer 107.

The encoding method used by the lossless encoding unit 106 may be variable-length encoding or arithmetic encoding, for example. The variable-length encoding may be CAVLC (Context-Adaptive Variable Length Coding) specified in AVC, for example. The arithmetic encoding may be CABAC (Context-Adaptive Binary Arithmetic Coding), for example.

The accumulation buffer 107 temporarily holds the encoded data supplied from the lossless encoding unit 106. The accumulation buffer 107 outputs the encoded data held therein to a recording device (a recording medium) or a transmission path or the like (not shown) in a later stage, for example, at a predetermined time. That is, the accumulation buffer 107 also serves as a transmission unit that transmits encoded data.

The transform coefficient quantized by the quantization unit 105 is also supplied to the inverse quantization unit 108. The inverse quantization unit 108 inversely quantizes the quantized transform coefficient by a method compatible with the quantization performed by the quantization unit 105. The inverse quantization method may be any method as long as the method is compatible with the quantization process performed by the quantization unit 105. The inverse quantization unit 108 supplies the obtained transform coefficient to the inverse orthogonal transform unit 109.

The inverse orthogonal transform unit 109 performs an inverse orthogonal transform on the transform coefficient supplied from the inverse quantization unit 108, by a method compatible with the orthogonal transform process performed by the orthogonal transform unit 104. This inverse orthogonal transform may be performed by any method as long as the method is compatible with the orthogonal transform process performed by the orthogonal transform unit 104. The output subjected to the inverse orthogonal transform (the restored difference information) is supplied to the arithmetic operation unit 110.

The arithmetic operation unit 110 obtains a locally decoded image (a decoded image) by adding the predicted image supplied from the intra prediction unit 114 or the motion prediction/compensation unit 115 via the predicted image selection unit 116 to the restored difference information that is the inverse orthogonal transform result supplied from the inverse orthogonal transform unit 109. The decoded image is supplied to the deblocking filter 111 or the frame memory 112.

The deblocking filter 111 performs, as appropriate, a deblocking filtering process on the decoded image supplied from the arithmetic operation unit 110. For example, the deblocking filter 111 removes block distortion fromthe decoded image by performing a deblocking filtering process on the decoded image.

The deblocking filter 111 supplies the result of the filtering process (the decoded image subjected to the filtering process) to the frame memory 112. As described above, the decoded image that is output from the arithmetic operation unit 110 can be supplied to the frame memory 112 without passing through the deblocking filter 111. That is, the filtering process by the deblocking filter 111 can be skipped.

The frame memory 112 stores the supplied decoded image, and supplies the stored decoded image as a reference image to the selection unit 113 at a predetermined time.

The selection unit 113 selects a supply destination of the reference image supplied from the frame memory 112. In the case of an inter prediction, for example, the selection unit 113 supplies the reference image supplied from the frame memory 112, to the motion prediction/compensation unit 115.

The intra prediction unit 114 performs intra predictions (intra-screen predictions) to generate a predicted image by using the pixel values in the current picture that is the reference image supplied from the frame memory 112 via the selection unit 113. In the generation of the predicted image, Prediction Units (PUs) are basically used as units of processing. The intra prediction unit 114 performs the intra predictions in more than one intra prediction mode that is prepared in advance.

The intra prediction unit 114 generates predicted images in all the candidate intra prediction modes, evaluates the cost function values of the respective predicted images by using the input image supplied from the screen rearrangement buffer 102, and selects the optimum mode. After selecting the optimum intra prediction mode, the intra prediction unit 114 supplies the predicted image generated in the optimum intra prediction mode to the predicted image selection unit 116.

As described above, the intra prediction unit 114 also supplies the intra prediction mode information indicating the adopted intra prediction mode, to the lossless encoding unit 106 to encode the intra prediction mode information, where appropriate.

Using the input image supplied from the screen rearrangement buffer 102, and the reference image supplied from the frame memory 112 via the selection unit 113, the motion prediction/compensation unit 115 performs motion predictions (inter predictions), with PUs basically being units of processing. The motion prediction/compensation unit 115 supplies a detected motion vector to the motion vector encoding unit 121, and performs a motion compensation process in accordance with the detected motion vector, to generate a predicted image (inter-predicted image information). The motion prediction/compensation unit 115 performs such inter predictions in more than one inter prediction mode that is prepared in advance.

The motion prediction/compensation unit 115 generates a difference motion vector that is the difference between the motion vector of the current region and the predicted motion vector of the current region supplied from the motion vector encoding unit 121. Using the input image supplied from the screen rearrangement buffer 102 and information about the generated difference motion vector, the motion prediction/compensation unit 115 evaluates the cost function value of each predicted image, and selects the optimum mode. After selecting the optimum inter prediction mode, the motion prediction/compensation unit 115 supplies the predicted image generated in the optimum inter prediction mode to the predicted image selection unit 116.

When the information indicating the selected inter prediction mode and encoded data are decoded, the motion prediction/compensation unit 115 supplies the necessary information for performing processes in the inter prediction mode, to the lossless encoding unit 106 to encode the information. The necessary information includes the information about the generated difference motion vector, predicted motion vector information containing a flag indicating the index of the predicted motion vector, and the like.

The predicted image selection unit 116 selects the supplier of a predicted image to be supplied to the arithmetic operation unit 103 and the arithmetic operation unit 110. In the case of inter encoding, for example, the predicted image selection unit 116 selects the motion prediction/compensation unit 115 as the supplier of a predicted image, and supplies the predicted image supplied from the motion prediction/compensation unit 115 to the arithmetic operation unit 103 and the arithmetic operation unit 110.

Based on the bit rate of the encoded data accumulated in the accumulation buffer 107, the rate control unit 117 controls the quantization operation rate of the quantization unit 105 so as not to cause an overflow or underfloor.

The motion vector encoding unit 121 predicts the motion vector of the current region detected by the motion prediction/compensation unit 115 from the motion vector of a neighboring region. In other words, the motion vector encoding unit 121 generates the predicted motion vectors to be used for encoding or decoding the motion vector of the current region.

Specifically, the motion vector encoding unit 121 generates predicted motion vectors (predictors) of the current region by using the motion vector of a neighboring region temporally or spatially adjacent to the current region.

The types of the predicted motion vectors include a temporally-predicted motion vector (temporal predictor) and a spatially-predicted motion vector (spatial predictor). A temporally-predicted motion vector is a predicted motion vector generated by using the motion vector of a temporally-neighboring region that is temporally adjacent to the current region. A spatially-predicted motion vector is a predicted motion vector generated by using the motion vector of a spatially-neighboring region that is spatially adjacent to the current region.

The motion vector encoding unit 121 supplies a generated temporally-predicted motion vector to the parity adjustment unit 122.

In the image encoding device 100, inputs and outputs of interlaced signals are handled. Of the two fields constituting one frame in an interlaced signal, the field that is spatially located at the top is called a top field, and the field that is spatially located at the bottom is called a bottom field. The type of a field that is a top field or a bottom field is called a parity.

The motion vector encoding unit 121 supplies information indicating the parity relation represented by the motion vector of the current region and the parity relation represented by the motion vector of a temporally-neighboring region (or a temporally-predicted motion vector) to the parity adjustment unit 122. The parity relation represented by the motion vector of the current region is a relation between the parity of the current region and the parity of the current reference region to be referenced to by the motion vector of the current region. The parity relation represented by the motion vector of a temporally-neighboring region is a relation between the parity of the temporally-neighboring region and the parity of the neighboring reference region to be referenced by the motion vector of the temporally-neighboring region.

In response to those supplies, the temporally-predicted motion vector subjected to shift adjustment is supplied from the parity adjustment unit 122. The motion vector encoding unit 121 supplies the generated spatially-predicted motion vector or the temporally-predicted motion vector subjected to the shifting, whichever is the optimum predicted motion vector, to the motion prediction/compensation unit 115.

By referencing the parity-related information supplied from the motion vector encoding unit 121, the parity adjustment unit 122 performs shift adjustment on the temporally-predicted motion vector information in accordance with the parity relation indicated by the motion vector information about the current region and the parity relation indicated by the motion vector information about the temporally-neighboring region. The parity adjustment unit 122 supplies the temporally-predicted motion vector subjected to the shift adjustment, to the motion vector encoding unit 121.

In this embodiment, a motion vector prediction is a process to generate predicted motion vectors, and motion vector encoding is described as a process to generate predicted motion vectors and calculate a difference motion vector by using the generated predicted motion vectors. That is, a motion vector encoding process include a motion vector prediction process. Likewise, motion vector decoding is described as a process to generate a predicted motion vector and reconstruct a motion vector by using the generated predicted motion vectors. That is, a motion vector decoding process includes a motion vector prediction process.

The above described neighboring region adjacent to the current region is also an adjacent region that is located in the vicinity of the current region, and the two terms will be used to refer to the same region in the following description.

[¼ Pixel Precision Motion Predictions]

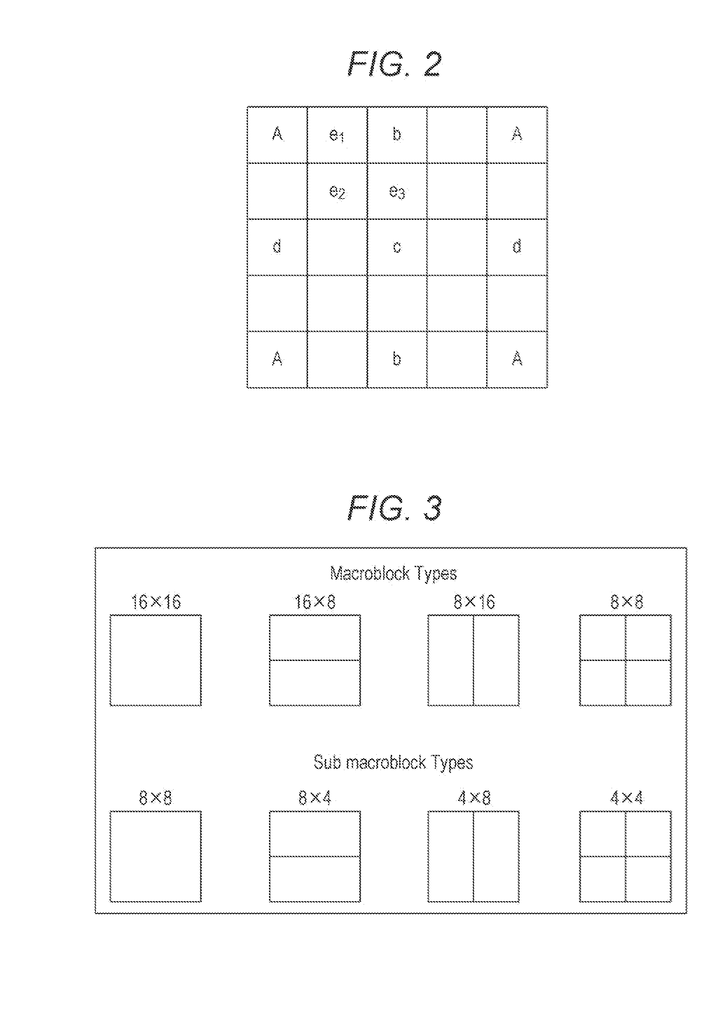

FIG. 2 is a diagram for explaining an example motion prediction/compensation process with ¼ pixel precision specified in AVC. In FIG. 2, each square represents a pixel. Among those squares, each A represents the position of an integer precision pixel stored in the frame memory 112, “b”, “c”, and “d” represent the positions of ½ precision pixels, and e1, e2, and e3 represent the positions of ¼ precision pixels.

In the following, the function Clip 1( ) is defined as shown in the following equation (1).

$$\begin{matrix}[ Mathematical Formula 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

When an input image has 8-bit precision, for example, the value of max₋pix in the equation (1) is 255.

The pixel values in the positions represented by b and d are generated by using a 6-tap FIR filter, as shown in the following equations (2) and (3).

[Mathematical Formula 2]

F=A₋₂−5·A₋₁+20·A₀+20·A₁−5·A₂+A₃ (2)

[Mathematical Formula 3]

b,d=Clip1((F+16)>>5) (3)

The pixel value in the position represented by c is generated by using a 6-tap FIR filter in the horizontal direction and the vertical direction, as shown in the following equations (4) through (6).

[Mathematical Formula 4]

F=b₋₂−5·b₋₁+20·b₀+20·b₁−5·b₂+b₃ (4)

or

[Mathematical Formula 5]

F=d₋₂−5·d₋₁+20·d₀+20·d₁−5·d₂+d₃ (5)

[Mathematical Formula 6]

c=Clip1((F+512)>>10) (6)

The Clip operation is only once performed at last, after both the horizontal product-sum operation and the vertical product-sum operation are performed.

Meanwhile, e1 through e3 are generated through linear interpolations, as shown in the following equations (7) through (9).

[Mathematical Formula 7]

e₁=(A+b+1)>>1 (7)

[Mathematical Formula 8]

e₂=(b+d+1)>>1 (8)

[Mathematical Formula 9]

e₃=(b+c+1)>>1 (9)

[Macroblocks]

FIG. 3 are diagrams showing examples of macroblocks according to AVC.

In MPEG2, each unit in the motion prediction/compensation process is formed with 16×16 pixels in a frame motion compensation mode, and the motion prediction/compensation process is performed. In a field motion compensation mode, each unit is formed with 16×8 pixels for each of a first field and a second field, and the motion prediction/compensation process is performed.

In AVC, on the other hand, each one macroblock formed with 16×16 pixels is divided into 16×16, 16×8, 8×16, or 8×8 partitions, as shown in FIG. 3, and those partitions can have motion vector information independently of one another on a sub macroblock basis. Each 8×8 partition can be further divided into 8×8, 8×4, 4×8, or 4×4 sub-macroblocks that can have motion vector information independently of one another, as shown in FIG. 3.

According to AVC, however, there is a possibility that an enormous amount of motion vector information is generated if such a motion prediction/compensation process is performed, as in the case with MPEG2. Directly encoding the generated motion vector information might lead to a decrease in encoding efficiency.

[Motion Vector Median Predictions]

To solve this problem, the method described below is used according to AVC, and a decrease in the amount of encoded motion vector information is realized.

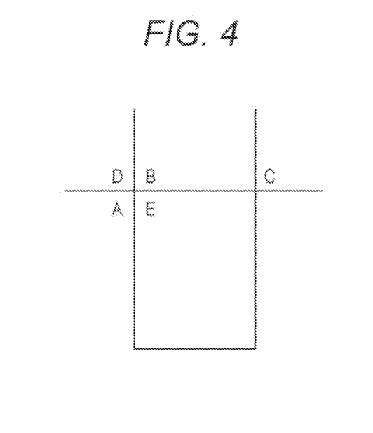

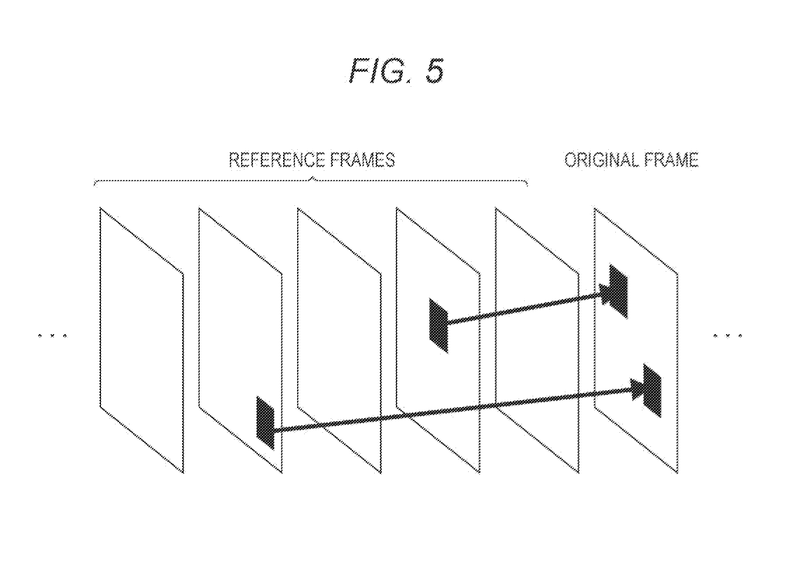

Each straight line shown in FIG. 4 indicates a boundary between motion compensation blocks. In FIG. 4, E represents the current motion compensation block to be encoded, and A through D each represent a motion compensation block that has already been encoded and is adjacent to E.

Where X is A, B, C, D, or E, mvx represents the motion vector information about a block X.

First, by using the motion vector information about the motion compensation blocks A, B, and C, predicted motion vector information pmvE about the motion compensation block E is generated through a median operation according to the following equation (10).

[Mathematical Formula 10]

pmv_{E}=med(mv_{A},mv_{B},mv_{c}) (10)

If the information about the motion compensation block C is “unavailable” because the block C is located at a corner of the image frame or the like, the information about the motion compensation block D is used instead.

In the compressed image information, the data mvdE to be encoded as the motion vector information about the motion compensation block E is generated by using pmvE according to the following equation (11).

[Mathematical Formula 11]

mvd_{E}=mv_{E}pmv_{E} (11)

In an actual process, processing is performed on the horizontal component and the vertical component of the motion vector information independently of each other.

[Multi-Reference Frames]

In AVC, the Multi-Reference Frame method, which is not specified by conventional image encoding techniques such as MPEG2 and H.263, is specified.

Referring now to FIG. 5, Multi-Reference Frames specified in AVC are described.

According to MPEG-2 and H.263, a motion prediction/compensation process is performed by referencing only one reference frame stored in a frame memory in the case of a P-picture. According to AVC, however, more than one reference frame is stored in a memory, and a different memory can be referenced for each macroblock, as shown in FIG. 5.

[Direct Modes]

Next, Direct Modes are described. Although the amount of motion vector information in a B-picture is very large, there are predetermined modes called Direct Modes in AVC.

In Direct Modes, motion vector information is not included in compressed image information. In an image decoding device, the motion vector information about the current block is calculated from the motion vector information about an adjacent block or the motion vector information about a co-located block that is a block located in the same position as the current block in a reference frame.

Direct Modes include the two modes: Spatial Direct Mode and Temporal Direct Mode. One of the two modes can be selected for each slice.

In Spatial Direct Mode, the motion vector information mvE about the current motion compensation block E is calculated as shown in the following equation (12).

mvE=pmvE (12)

That is, motion vector information that is generated through a median prediction is applied to the current block.

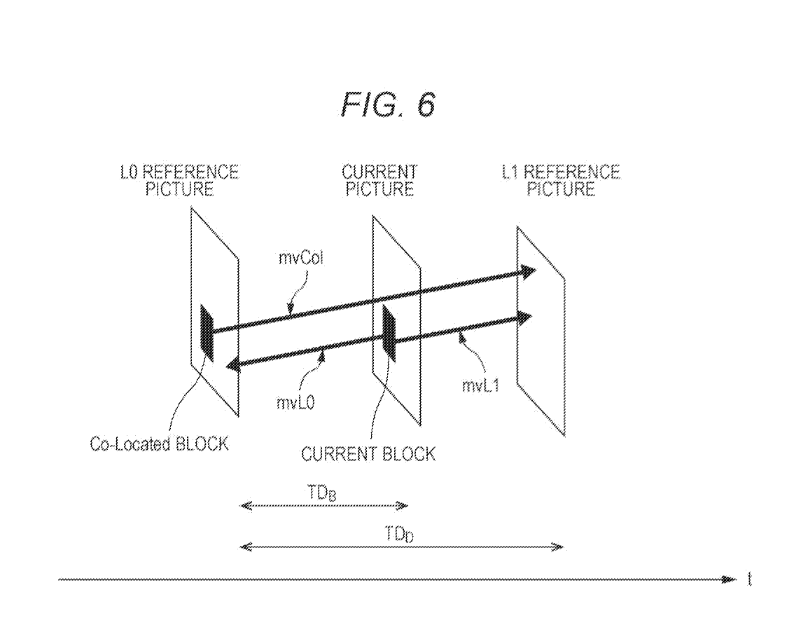

Referring now to FIG. 6, Temporal Direct Mode is described.

In FIG. 6, a block located at the address in the same space as the current block in a L0 reference picture is referred to as a co-located block, and the motion vector information about the co-located block is represented by mvcol. Also, TDB represents the distance on the temporal axis between the picture and the L0 reference picture, and TDD represents the distance on the temporal axis between the L0 reference picture and an L1 reference picture.

At this point, the motion vector information mvL0 about L0 and the motion vector information mvL1 about L1 in the current picture are calculated as shown in the following equations (13) and (14).

$$\begin{matrix}[ Mathematical Formula 12 ] & \\ {mv}_{L 0} = \frac{{TD}_{B}}{{TD}_{D}} {mv}_{col} & ( 13 ) \\ [ Mathematical Formula 13 ] & \\ {mv}_{L 1} = \frac{{TD}_{D} - {TD}_{B}}{{TD}_{D}} {mv}_{col} & ( 14 )\end{matrix}$$

In AVC compressed image information, information TD indicating a distance on the temporal axis does not exist, and therefore, the calculations according to the above mentioned equations (12) and (13) are performed by using POC (Picture Order Count).

In AVC compressed image information, Direct Modes can be defined on a 16×16 pixel macroblock basis or an 8×8 pixel block basis.

[Prediction Mode Selection] Next, prediction mode selection according to AVC is described. To achieve higher encoding efficiency according to AVC, it is critical to select an appropriate prediction mode.

An example of such a selection method is a method stored in the AVC reference software, called JM (Joint Model) (available at http://iphome.hhi.de/suehring/tml/index.htm).

In JM, the two mode determination methods described below, High Complexity Mode and Low Complexity Mode, can be selected. By either of the methods, a cost function value as to each prediction mode is calculated, and the prediction mode that minimizes the cost function value is selected as the optimum mode for the current sub-macroblock or macroblock.

A cost function in High Complexity Mode is expressed by the following equation (15).

Cost(ModeεΩ)=D+λ*R (15)

Here, Ω represents the universal set of candidate modes for encoding the current block or macroblock, and D represents the difference energy between a decoded image and an input image when encoded is performed in the current prediction mode. λ represents the Lagrange's undetermined multiplier provided as a quantization parameter function. R represents the total bit rate in a case where encoding is performed in the current mode, including the orthogonal transform coefficient.

That is, to perform encoding in High Complexity Mode, a provisional encoding process needs to be performed in all the candidate modes to calculate the above parameters D and R, and therefore, a larger amount of calculation is required.

A cost function in Low Complexity Mode is expressed by the following equation (16).

Cost(ModeεΩ)=D+QP2Quant(QP)*HeaderBit (16)

Here, D differs from that in High Complexity Mode, and represents the difference energy between a predicted image and an input image. QP2Quant(QP) represents a function of a quantization parameter QP, and HeaderBit represents the bit rate related to information that excludes the orthogonal transform coefficient and belongs to Header, such as a motion vector and the mode.

That is, in Low Complexity Mode, a prediction process needs to be performed for each of the candidate modes, but a decoded image is not required. Therefore, there is no need to perform an encoding process. Accordingly, the amount of calculation is smaller than that in High Complexity Mode.

[MV Competition Among Motion Vectors]

Next, motion vector encoding is described. To improve motion vector encoding using median predictions as described above with reference to FIG. 4, Non-Patent Document 1 suggests the method described below.

That is, in addition to “Spatial Predictor (spatially-predicted motion vector)” that is defined in AVC and is determined through a median prediction, “Temporal Predictor (temporally-predicted motion vector)” or “Spatio-Temporal Predictor (temporally- and spatially-predicted motion vector)” can be adaptively used as predicted motion vector information. This suggested method is called MV competition in AVC. In HEVC, on the other hand, this suggested method is called Advanced Motion Vector Prediction (AMVP). Therefore, this suggested method will be hereinafter referred to as AMVP in the description below.

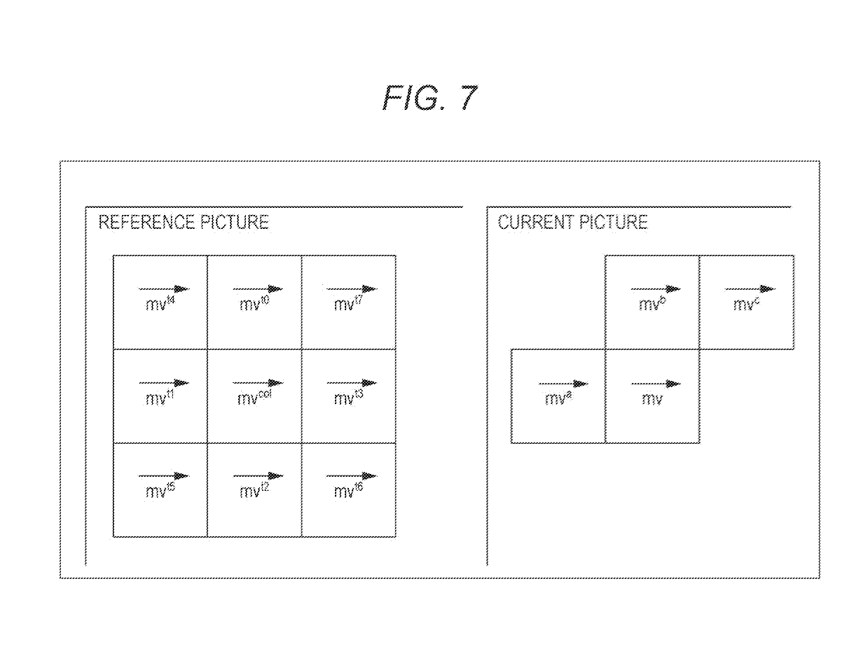

In FIG. 7, “mvcol” represents motion vector information related to a Co-Located block with respect to the current block. Where mvtk (k=0 to 8) represents motion vector information about an adjacent block, the predicted motion vector information (Predictors) is defined by the following equations (17) through (19). It should be noted that a Co-Located block with respect to the current block is a block having the same x-y coordinates as the current block in the reference picture that is referenced by the current picture.

Temporal Predictor:

[Mathematical Formula 14]

mvₜₘ₅=median{mv_{col},mvₜ₀, . . . ,mvₜ₈} (17)

[Mathematical Formula 15]

mvₜₘ₉=median{mv_{col},mvₜ₀, . . . ,mvₜ₈} (18)

Spatio-Temporal Predictor:

[Mathematical Formula 16]

mvₛₚₜ=median{mv_{col},mv_{col},mvₐ,mv_{b},mv_{c}} (19)

In the image encoding device 100, the cost function values for respective blocks are calculated by using the predicted motion vector information about the respective blocks, and optimum predicted motion vector information is selected. Through the compressed image information, a flag indicating the information (index) about which predicted motion vector information has been used is transmitted for each block.

[Coding Units]

Next, Coding Units specified in HEVC are described. The macroblock size of 16×16 pixels is not optimal for a large frame such as an UHD (Ultra High Definition: 4000×2000 pixels) frame to be encoded by a next-generation encoding method.

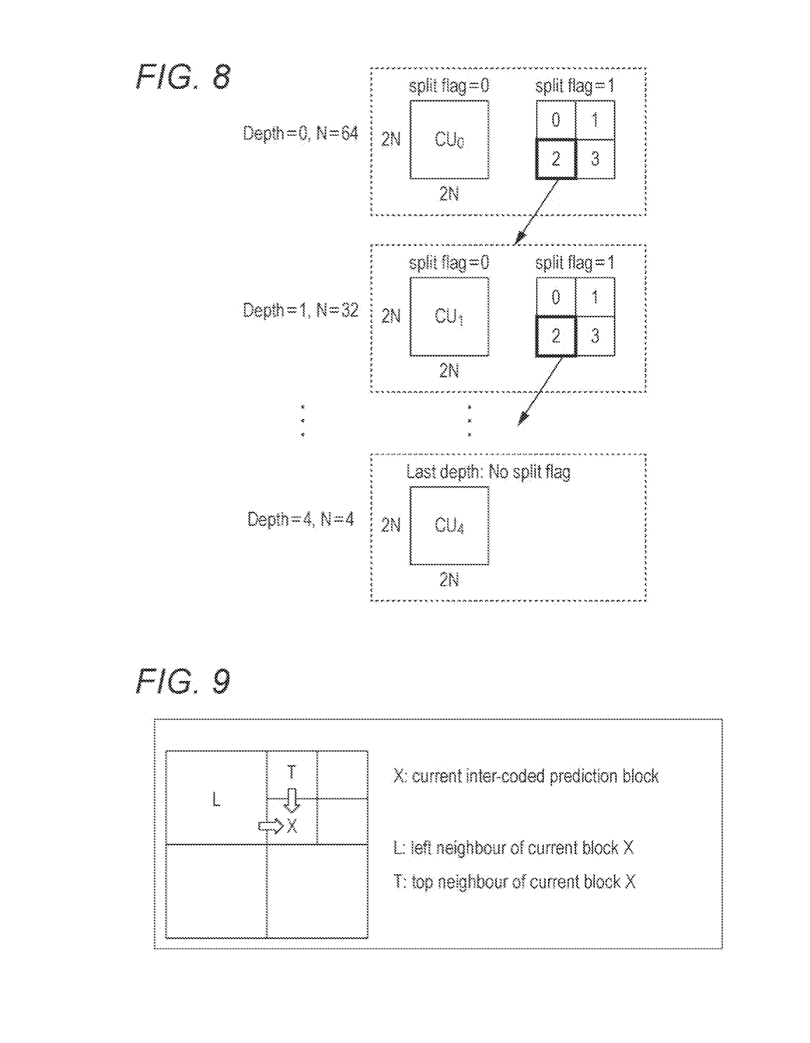

Specifically, AVC specifies a hierarchical structure formed with macroblocks and sub-macroblocks as described above with reference to FIG. 3, but HEVC specifies Coding Units (CUs) as shown in FIG. 8.

CUs are also called Coding Tree Blocks (CTBs), and are partial regions of picture-based images that have the same roles as those of macroblocks compliant with AVC. While the size of the latter is limited to 16×16 pixels, the size of the former is not limited to a certain size, and may be designated by the compressed image information in each sequence.

For example, in a sequence parameter set (SPS) contained in encoded data to be output, the largest coding unit (LCU) and the smallest coding unit (SCU) of the CUs are specified.

In each LCU, split-flag=1 is set within a range not smaller than the SCU size, so that each LCU can be divided into CUs of a smaller size. In the example shown in FIG. 8, the size of the LCU is 128, and the greatest hierarchical depth is 5. When the value of split₋flag is “1”, a CU of 2N×2N in size is divided into CUs of N×N in size, which is one hierarchical level lower.

Each of the CUs is further divided into Prediction Units (PUs) that are processing-unit regions (partial regions of picture-based images) for intra or inter predictions, or are divided into Transform Units (TUs) that are processing-unit regions (partial regions of picture-based images) for orthogonal transforms. At present, 16×16 and 32×32 orthogonal transforms, as well as 4×4 and 8×8 orthogonal transforms, can be used according to HEVC.

In a case where CUs are defined, and each process is performed on the CU basis in the same manner as with HEVC, the macroblocks compliant with AVC can be considered equivalent to the LCUs, and the blocks (sub-blocks) can be considered equivalent to the CUs. Also, motion compensation blocks compliant with AVC can be considered equivalent to the PUs. However, a CU has a hierarchical structure. Therefore, the size of the LCU on the highest hierarchical level is normally as large as 128×128 pixels, which is larger than the size of each macroblock compliant with AVC, for example.

In the following description, the LCUs include macroblocks compliant with AVC, and the CUs include blocks (sub-blocks) compliant with AVC.

[Motion Partition Merging]

Next, a merge mode according to HEVC is described. As one of the motion vector encoding methods described above with reference to FIG. 7, there is a suggested method called Motion Partition Merging (the merge mode) as shown in FIG. 9. According to this method, the two flags, Merge Flag and Merge Left Flag, are transmitted as merge information that is information related to the merge mode.

When Merge Flag is 1, the motion information about the current region X is the same as the motion information about an adjacent region T that is located adjacent to the top edge of the current region, or the motion information about an adjacent region L that is located adjacent to the left edge of the current region. At this point, Merge Left Flag is included in the merge information, and is transmitted. When Merge Flag is 0, the motion information about the current region X differs from both the motion information about the adjacent region T and the motion information about the adjacent region L. In this case, the motion information about the current region X is transmitted.

When the motion information about the current region X is the same as the motion information about the adjacent region L, Merge Flag is 1, and Merge Left Flag is 1. When the motion information about the current region X is the same as the motion information about the adjacent region T, Merge Flag is 1, and Merge Left Flag is 0.

That is, in the merge mode, a spatially-predicted motion vector and a temporally-predicted motion vector are also determined from an adjacent block, and the optimum predicted motion vector is selected from those motion vectors. In the merge mode, when the determined predicted motion vector is the same as the motion information about the current block, only flag information is transmitted.

[Interlaced Signal Encoding]

Next, interlaced signal encoding according to AVC is described. In an interlaced signal, a picture is formed alternately with top fields and bottom fields that have different parities (top and bottom). According to AVC, when an image to be input is an interlaced signal, frame encoding or field encoding can be selected for each picture or each macroblock pair.

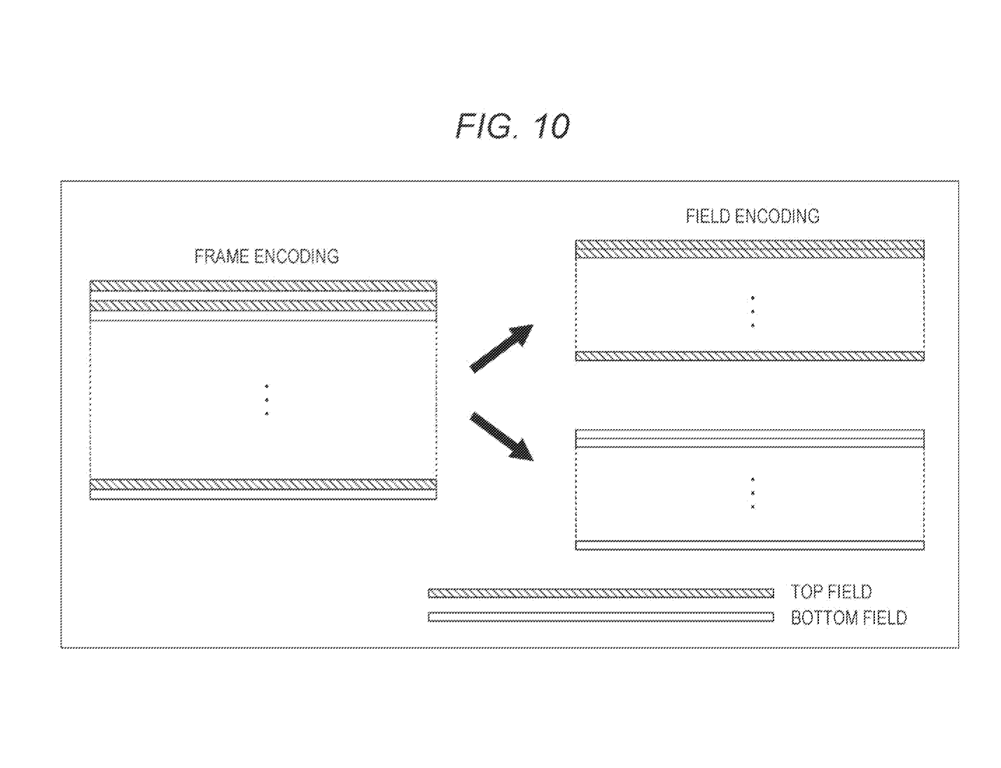

FIG. 10 is a diagram showing an example of interlaced signal encoding on the picture basis. The example in FIG. 10 shows, from left, a frame-encoded picture and a field-encoded picture. The shaded fields are top fields, and the unshaded fields are bottom fields.

In frame encoding, a picture is encoded so as to alternately include the top fields and the bottom fields as they are. In field encoding, on the other hand, a picture is divided between the top fields and the bottom fields, and is encoded for each parity.

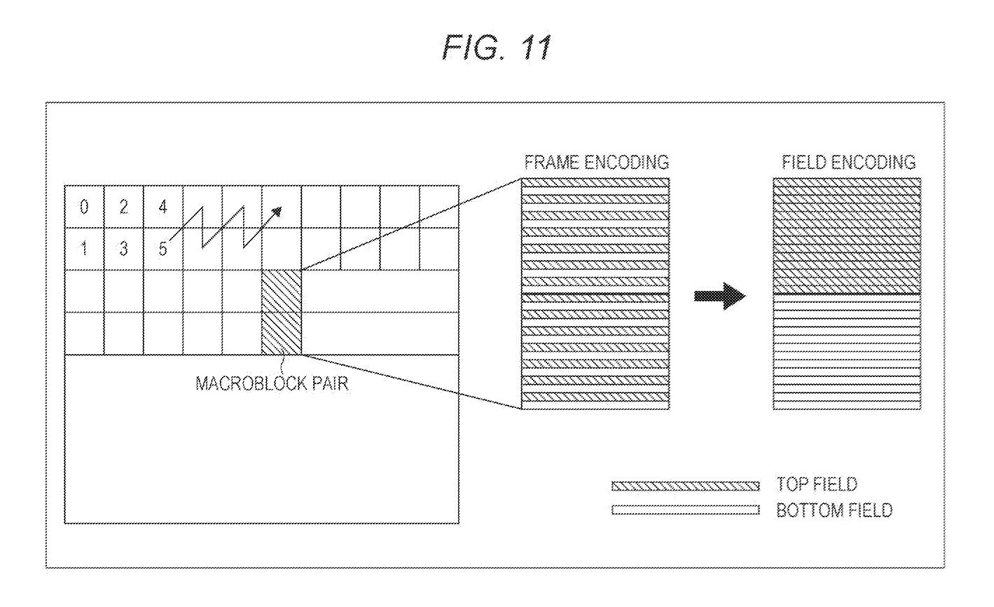

FIG. 11 is a diagram showing an example of interlaced signal encoding on the macroblock pair basis. According to AVC, macroblocks formed with 16×16 pixels are normally used, and the respective squares in the drawing represent individual macroblocks. The macroblocks are sequentially set, starting from the upper left corner of the image, for example. In this example, the uppermost and leftmost macroblock is the macroblock with number 0, and the neighboring macroblock below the macroblock with number 0 is the macroblock with number 1. Further, the neighboring macroblock located on the left side of the macroblock with number 0 is the macroblock with number 2, and the neighboring macroblock located on the right side of the macroblock with number 0 is the macroblock with number 3.

According to AVC, frame encoding or field encoding can be adaptively selected for each macroblock pair formed with two macroblocks vertically adjacent to each other in an image. In this example, one macroblock is formed with the two macroblocks with number 0 and number 1, and one macroblock is formed with the two macroblocks with number 2 and number 3. Likewise, the other macroblock pairs are formed.

In the case of the macroblock pairs shown in FIG. 11, a macroblock pair in field encoding is encoded so as to alternately include the top fields and the bottom fields as they are, as in the case of the picture-based encoding described above with reference to FIG. 10. In field encoding, on the other hand, a macroblock pair is divided between the top fields and the bottom fields, and is encoded for each parity.

The above described functions according to AVC for interlaced signals can also be applied to HEVC. However, when a temporally-predicted motion vector in AMVP described above with reference to FIG. 7 or in the merge mode described above with reference to FIG. 9 is applied to an interlaced signal, the temporally-predicted motion vector is generated between different parities in some cases.

Specifically, in the case of an interlaced signal, when a temporally-predicted motion vector is generated between different parities, the level of evaluation of the temporally-predicted motion vector becomes lower due to phase shifting in the vertical direction between the different parities, and the spatially-predicted motion vector is selected. The spatially-predicted motion vector does not necessarily have a high evaluation, and therefore, encoding efficiency might become lower.

[Example of the Parity Adjustment Method According to the Present Technique]

In view of the above, the parity adjustment unit 122 performs shift adjustment on the vertical component of a temporally-predicted motion vector in accordance with the parity relation represented by the motion vector of the current region and the parity relation represented by the motion vector of a temporally-neighboring region (or the temporally-predicted motion vector).

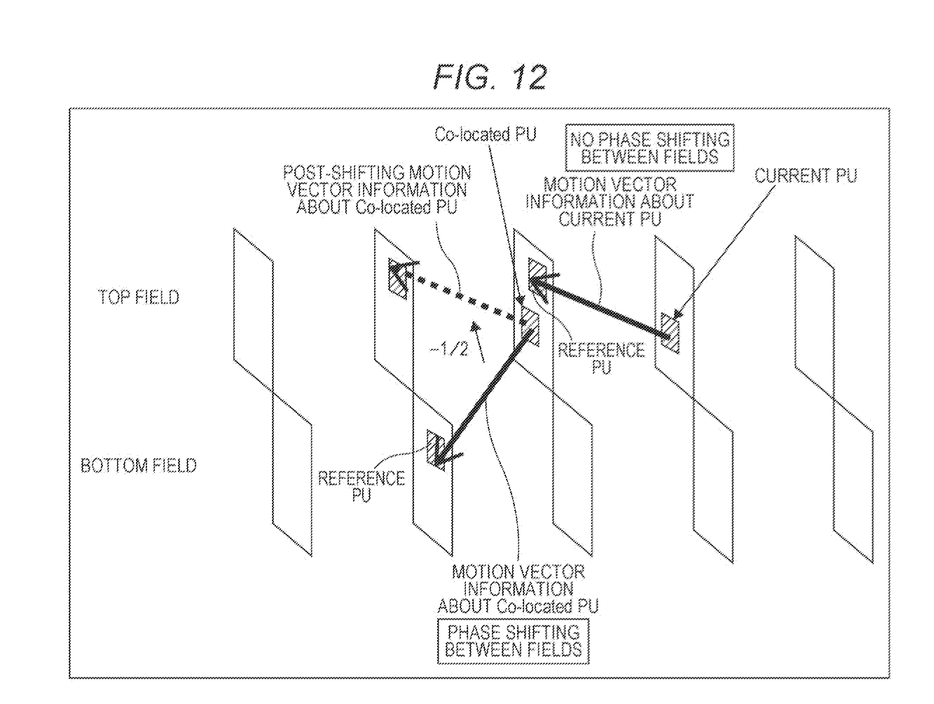

Referring now to FIGS. 12 through 14, examples of patterns that might appear when a temporally-predicted motion vector in AMVP or the merge mode is applied to an interlaced signal, and examples of shift adjustment are described. In the following description, “TB” represents a case where the field of the current region (hereinafter also referred to as the current PU) is a top field, and the field of the reference PU to be referenced by the motion vector of the current PU is a bottom field.

In the example shown in FIG. 12, the motion vector information about the current PU indicates “TT”, but the motion vector information (or temporally-predicted motion vector information) about a Co-located PU (or a temporally-neighboring PU) indicates “TB”.

The current PU and the reference PU to be referenced by the motion vector information about the current PU belong to top fields or fields of the same parity. Accordingly, the motion vector information about the current PU indicates “TT” (same parity), and there is no phase shifting between the fields.

On the other hand, the Co-located PU belongs to a top field, while the reference PU to be referenced by the motion vector information about the Co-located PU belongs to a bottom field. Therefore, the motion vector information about the Co-located PU indicates “TB” (different parities), and there is phase shifting between the fields.

That is, the motion vector information about the Co-located PU references a PU that is located half a phase lower, and therefore, encoding efficiency becomes lower.

In view of this, the parity adjustment unit 122 performs −½ shift adjustment on the vertical component of the motion vector information about the Co-located PU, to obtain post-shifting motion vector information about the Co-located PU as indicated by the arrow with a dashed line. In this manner, the phase shifting of the temporally-predicted motion vector can be adjusted.

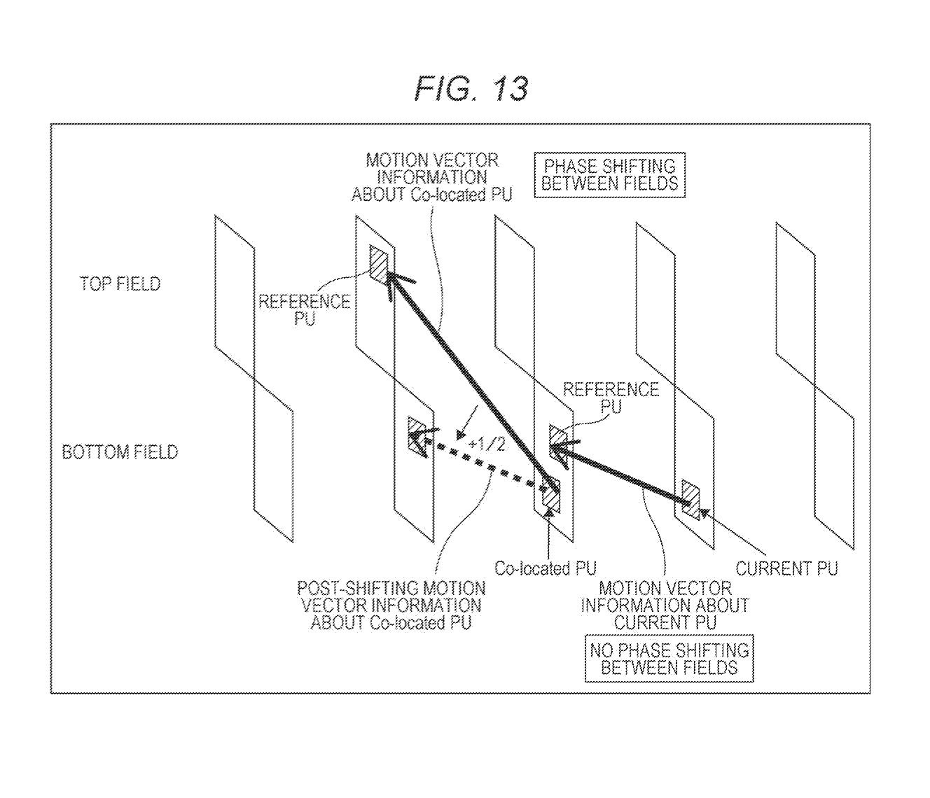

In the example shown in FIG. 13, the motion vector information about the current PU indicates “BB”, but the motion vector information about a Co-located PU indicates “BT”.

The current PU and the reference PU to be referenced by the motion vector information about the current PU belong to bottom fields or fields of the same parity. Accordingly, the motion vector information about the current PU indicates “BB” (same parity), and there is no phase shifting between the fields.

On the other hand, the Co-located PU belongs to a bottom field, while the reference PU to be referenced by the motion vector information about the Co-located PU belongs to a top field. Therefore, the motion vector information about the Co-located PU indicates “BT” (different parities), and there is phase shifting between the fields.

That is, the motion vector information about the Co-located PU references a parity that is located half a phase higher, and therefore, encoding efficiency becomes lower.

In view of this, the parity adjustment unit 122 performs +½ shift adjustment on the vertical component of the motion vector information about the Co-located PU, to obtain post-shifting motion vector information about the Co-located PU as indicated by the arrow with a dashed line. In this manner, the phase shifting of the temporally-predicted motion vector can be adjusted.

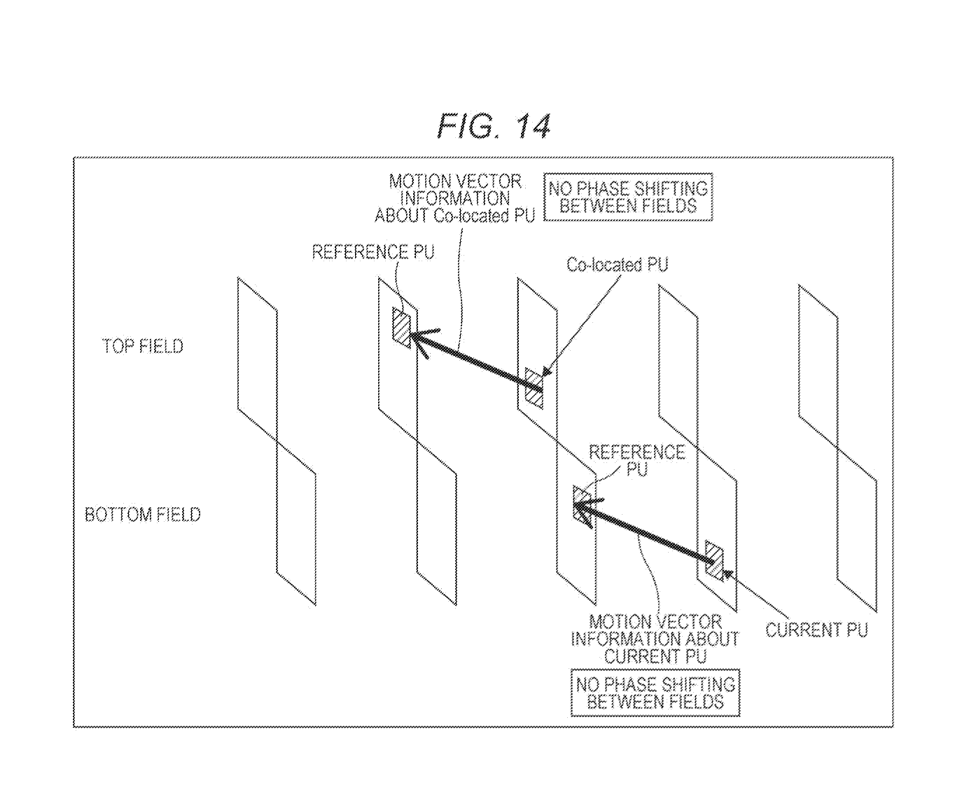

In the example shown in FIG. 14, the motion vector information about the current PU indicates “BB”, but the motion vector information about a Co-located PU indicates “TT”.

The current PU and the reference PU to be referenced by the motion vector information about the current PU belong to bottom fields or fields of the same parity. Accordingly, the motion vector information about the current PU indicates “BB” (same parity), and there is no phase shifting between the fields.

Meanwhile, the Co-located PU and the reference PU to be referenced by the motion vector information about the Co-located PU belong to top fields or fields of the same parity. Accordingly, the motion vector information about the Co-located PU indicates “TT” (same parity), and there is no phase shifting between the fields.

Since there is no need to perform shift adjustment on the vertical component of the motion vector information about the Co-located PU, the parity adjustment unit 122 sets the shift adjustment for the vertical component of the motion vector information about the Co-located PU to 0. That is, shift adjustment is prohibited in this case.

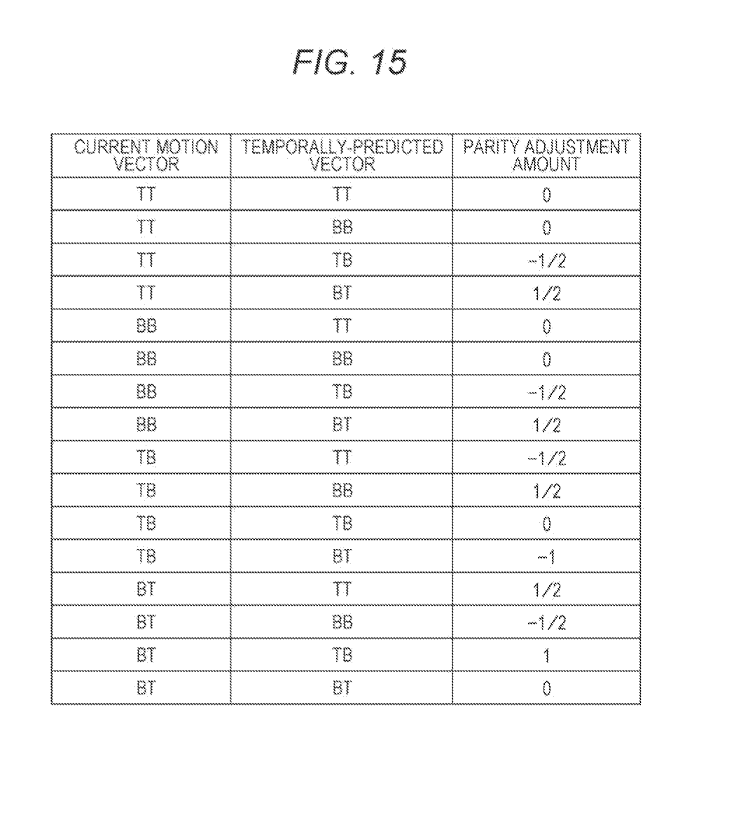

FIGS. 12 through 14 show only a few examples among many, and FIG. 15 collectively shows parity adjustment methods for all the cases. In the example shown in FIG. 15, the current motion vectors include the motion vectors of the current PUs shown in FIGS. 12 through 14, for example, and the temporally-predicted motion vectors include the motion vectors of the Co-located PUs shown in FIGS. 12 through 14, for example. The parity adjustment amounts are the amounts of shift adjustment to be performed by the parity adjustment unit 122.

Ina case where the current motion vector indicates “TT”, and the temporally-predicted motion vector indicates “TT”, the parity adjustment amount is 0, as in the case with the method described above with reference to FIG. 14. In a case where the current motion vector indicates “TT”, and the temporally-predicted motion vector indicates “BB”, the parity adjustment amount is 0, as in the case with the method described above with reference to FIG. 14.

Ina case where the current motion vector indicates “TT”, and the temporally-predicted motion vector indicates “TB”, the parity adjustment amount is −½, as in the case with the method described above with reference to FIG. 12. In a case where the current motion vector indicates “TT”, and the temporally-predicted motion vector indicates “BT”, the parity adjustment amount is ½, as in the case with the method described above with reference to FIG. 13.

Ina case where the current motion vector indicates “BB”, and the temporally-predicted motion vector indicates “TT”, the parity adjustment amount is 0, as in the case with the method described above with reference to FIG. 14. In a case where the current motion vector indicates “BB”, and the temporally-predicted motion vector indicates “BB”, the parity adjustment amount is 0, as in the case with the method described above with reference to FIG. 14.

In a case where the current motion vector indicates “BB”, and the temporally-predicted motion vector indicates “TB”, the parity adjustment amount is −½, as in the case with the method described above with reference to FIG. 12. In a case where the current motion vector indicates “BB”, and the temporally-predicted motion vector indicates “BT”, the parity adjustment amount is ½, as in the case with the method described above with reference to FIG. 13.

In a case where the current motion vector indicates “TB”, and the temporally-predicted motion vector indicates “TT”, the parity adjustment amount is −½. This is a case where the motion vector has phase shifting while the temporally-predicted motion vector has no phase shifting, which is the opposite of the method described above with reference to FIG. 12. Ina case where the current motion vector indicates “TB”, and the temporally-predicted motion vector indicates “BB”, the parity adjustment amount is ½. This is a case where the motion vector has phase shifting while the temporally-predicted motion vector has no phase shifting, which is the opposite of the method described above with reference to FIG. 13.

In a case where the current motion vector indicates “TB”, and the temporally-predicted motion vector indicates “TB”, the parity adjustment amount is 0, as in the case with the method described above with reference to FIG. 14. In a case where the current motion vector indicates “TB”, and the temporally-predicted motion vector indicates “BT”, the parity adjustment amount is −1. Specifically, in this case, the current motion vector references a PU located half a phase lower, the temporally-predicted motion vector references a PU located half a phase higher, and the two vectors have phase shifting in the opposite directions. Also, when seen from the field of the current PU, the reference region to be referenced by the temporally-predicted motion vector has −1-phase shifting.

In a case where the current motion vector indicates “BT”, and the temporally-predicted motion vector indicates “TT”, the parity adjustment amount is ½. This is a case where the motion vector has phase shifting while the temporally-predicted motion vector has no phase shifting, which is the opposite of the method described above with reference to FIG. 13. Ina case where the current motion vector indicates “BT”, and the temporally-predicted motion vector indicates “BB”, the parity adjustment amount is −½. This is a case where the motion vector has phase shifting while the temporally-predicted motion vector has no phase shifting, which is the opposite of the method described above with reference to FIG. 12.

Ina case where the current motion vector indicates “BT”, and the temporally-predicted motion vector indicates “TB”, the parity adjustment amount is 1. Specifically, in this case, the current motion vector references a PU located half a phase higher, the temporally-predicted motion vector references a PU located half a phase lower, and the two vectors have phase shifting in the opposite directions. Also, when seen from the field of the current PU, the reference region to be referenced by the temporally-predicted motion vector has 1-phase shifting. In a case where the current motion vector indicates “BT”, and the temporally-predicted motion vector indicates “BT”, the parity adjustment amount is 0, as in the case with the method described above with reference to FIG. 14.

To sum up the adjustment methods shown in FIG. 15, shift adjustment is performed on the vertical component of the temporally-predicted motion vector, when the parity relation represented by the current motion vector (between the current PU and its reference PU) differs from the parity relation represented by the temporally-predicted motion vector (between the temporally-neighboring PU and its reference PU). In other words, shift adjustment is performed on the vertical component of the temporally-predicted motion vector, when the phase shifting indicated by the parity relation between the current PU and its reference PU differs from the phase shifting indicated by the parity relation between the temporally-neighboring PU and its reference PU. The phase shifting includes zero phase shifting.

In the above description, examples in which motion vector values are adjusted have been described as parity adjustment methods. However, the fields of reference PUs may also be adjusted. For example, to perform parity adjustment, the field of a reference PU may be changed from a bottom field to a top field.

As described above, if motion vector encoding (predicted motion vector generation) in MVP or in the merge mode is applied in a case where an input image is an interlaced signal, efficiency of prediction using a temporally-predicted motion vector can be increased. As a result, efficiency of motion vector encoding can also be increased.

[Example Structures of the Motion Vector Encoding Unit and the Parity Adjustment Unit]

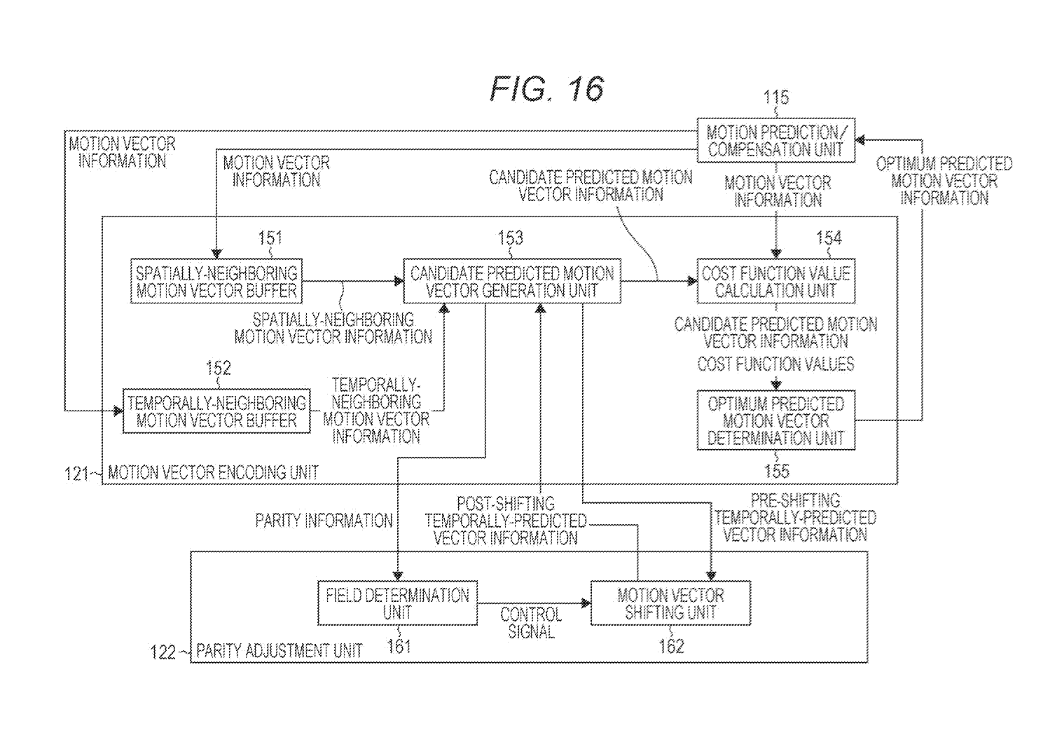

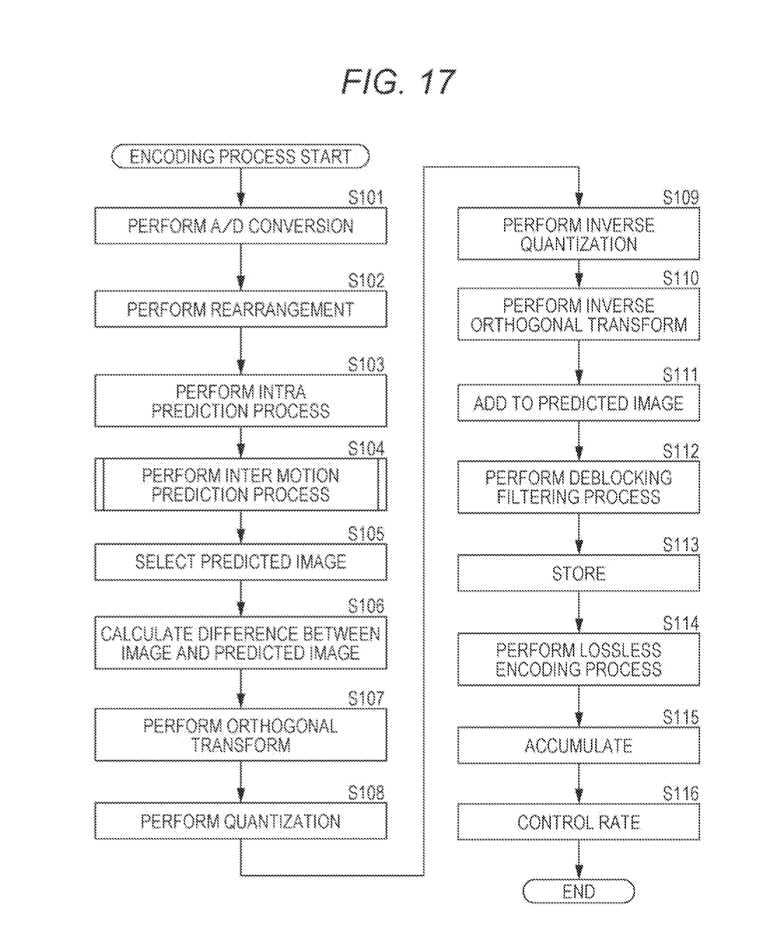

FIG. 16 is a block diagram showing typical example structures of the motion vector encoding unit 121 and the parity adjustment unit 122.

The motion vector encoding unit 121 of the example shown in FIG. 16 is designed to include a spatially-neighboring motion vector buffer 151, a temporally-neighboring motion vector buffer 152, a candidate predicted motion vector generation unit 153, a cost function value calculation unit 154, and an optimum predicted motion vector determination unit 155.

The parity adjustment unit 122 is designed to include a field determination unit 161 and a motion vector shifting unit 162.

Information about a motion vector in a determined optimum prediction mode is supplied from the motion prediction/compensation unit 115 to the spatially-neighboring motion vector buffer 151 and the temporally-neighboring motion vector buffer 152. Information about motion vectors in respective prediction modes detected by the motion prediction/compensation unit 115 is supplied to the cost function value calculation unit 154.

The spatially-neighboring motion vector buffer 151 is formed with a line buffer. The spatially-neighboring motion vector buffer 151 stores motion vector information supplied from the motion prediction/compensation unit 115 as information about the motion vector of a spatially-neighboring region that is spatially adjacent. The spatially-neighboring motion vector buffer 151 reads the information indicating the motion vector determined for the spatially-neighboring PU that is spatially adjacent to the current PU, and supplies the read information (spatially-neighboring motion vector information) to the candidate predicted motion vector generation unit 153.

The temporally-neighboring motion vector buffer 152 is formed with a memory. The temporally-neighboring motion vector buffer 152 stores motion vector information supplied from the motion prediction/compensation unit 115 as information about the motion vector of a temporally-neighboring region that is temporally adjacent. A region that is temporally adjacent is a region (a Co-located PU) at an address in the same space as the current region (the current PU) in a different picture in terms of temporal axis.

The temporally-neighboring motion vector buffer 152 reads the information indicating the motion vector determined for the temporally-neighboring PU that is temporally adjacent to the current PU, and supplies the read information (temporally-neighboring motion vector information) to the candidate predicted motion vector generation unit 153.

According to a method using AMVP or the merge mode described above with reference to FIG. 7 or 9, the candidate predicted motion vector generation unit 153 generates a spatially-predicted motion vector as a candidate predicted motion vector of the current PU by referencing the spatially-neighboring motion vector information supplied from the spatially-neighboring motion vector buffer 151. The candidate predicted motion vector generation unit 153 supplies information indicating the generated spatially-predicted motion vector as candidate predicted motion vector information to the cost function value calculation unit 154.

According to the method using AMVP or the merge mode, the candidate predicted motion vector generation unit 153 generates a temporally-predicted motion vector as a candidate predicted motion vector of the current PU by referencing the temporally-neighboring motion vector information supplied from the temporally-neighboring motion vector buffer 152.

The candidate predicted motion vector generation unit 153 supplies information about the generated temporally-predicted motion vector as pre-shifting temporally-predicted motion vector information to the motion vector shifting unit 162. At this point, the candidate predicted motion vector generation unit 153 supplies parity information about the current PU and its reference PU, and parity information about the temporally-neighboring PU and its reference PU, to the field determination unit 161. After receiving information about a post-shifting temporally-predicted motion vector from the motion vector shifting unit 162, the candidate predicted motion vector generation unit 153 supplies the information as candidate predicted motion vector information to the cost function value calculation unit 154.

The cost function value calculation unit 154 calculates cost function values with respect to respective candidate predicted motion vectors, and supplies the calculated cost function values, as well as the candidate predicted motion vector information, to the optimum predicted motion vector determination unit 155.

The optimum predicted motion vector determination unit 155 determines the optimum predicted motion vector for the current PU to be the candidate predicted motion vector with the smallest cost function value supplied from the cost function value calculation unit 154, and supplies the information to that effect to the motion prediction/compensation unit 115.

Using the information about the optimum predicted motion vector supplied from the optimum predicted motion vector determination unit 155, the motion prediction/compensation unit 115 generates a difference motion vector that is the difference from the motion vector, and calculates the cost function values with respect to respective prediction modes. The motion prediction/compensation unit 115 determines the optimum inter prediction mode to be the prediction mode with the smallest cost function value.

The motion prediction/compensation unit 115 supplies the predicted image in the optimum inter prediction mode to the predicted image selection unit 116. The motion prediction/compensation unit 115 supplies the motion vector in the optimum inter prediction mode to the spatially-neighboring motion vector buffer 151 and the temporally-neighboring motion vector buffer 152. The motion prediction/compensation unit 115 also supplies the generated difference motion vector information to the lossless encoding unit 106 for encoding.

The field determination unit 161 receives, from the candidate predicted motion vector generation unit 153, parity information containing the information indicating the parity relation between the current PU and its reference PU, and the information indicating the parity relation between the temporally-neighboring PU and its reference PU. Based on the parity information, the field determination unit 161 determines the field of each region, and calculates the adjustment amount for the vertical component of the temporally-predicted motion vector in accordance with the two parity relations. The field determination unit 161 supplies a control signal containing the calculated adjustment amount to the motion vector shifting unit 162.

The motion vector shifting unit 162 receives information indicating the pre-shifting temporally-predicted motion vector from the candidate predicted motion vector generation unit 153. Based on the control signal from the field determination unit 161, the motion vector shifting unit 162 shifts the received temporally-predicted motion vector by an adjustment method shown in FIG. 15. The motion vector shifting unit 162 supplies information indicating the post-shifting temporally-predicted motion vector to the candidate predicted motion vector generation unit 153.

[Flow of an Encoding Process]

Next, the flow of each process to be performed by the above described image encoding device 100 is described. Referring first to the flowchart shown in FIG. 17, an example flow of an encoding process is described.

In step S101, the A/D converter 101 performs an A/D conversion on an input image. In step S102, the screen rearrangement buffer 102 stores the image subjected to the A/D conversion, and rearranges the respective pictures in encoding order, instead of displaying order. In step S103, the intra prediction unit 114 performs an intra prediction process in intra prediction modes.

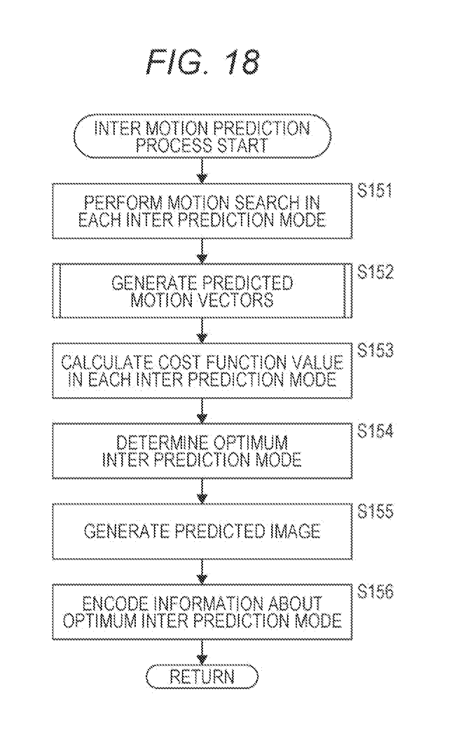

In step S104, the motion prediction/compensation unit 115, the motion vector encoding unit 121, and the parity adjustment unit 122 perform an inter motion prediction process to perform motion predictions and motion compensation in inter prediction modes. This inter motion prediction process will be described later in detail, with reference to FIG. 18.

The motion vector of the current PU is detected by the processing in step S104, respective predicted motion vectors of the current PU are generated, and the vertical component of the generated temporally-predicted motion vector is adjusted based on the parity information. The optimum predicted motion vector for the PU is determined between the adjusted temporally-predicted motion vector and the generated spatially-predicted motion vector, the optimum inter prediction mode is determined, and a predicted image is generated in the optimum inter prediction mode.

The predicted image and the cost function value in the determined optimum inter prediction mode are supplied from the motion prediction/compensation unit 115 to the predicted image selection unit 116. Also, information about the determined optimum inter prediction mode, information about the optimum predicted motion vector, and information indicating the difference between the predicted motion vector and the motion vector are supplied to the lossless encoding unit 106, and are subjected to lossless encoding in step S114, which will be described later.

In step S105, the predicted image selection unit 116 determines the optimum mode based on the respective cost function values that are output from the intra prediction unit 114 and the motion prediction/compensation unit 115. That is, the predicted image selection unit 116 selects the predicted image generated by the intra prediction unit 114 or the predicted image generated by the motion prediction/compensation unit 115.

In step S106, the arithmetic operation unit 103 calculates the difference between the image rearranged by the processing in step S102 and the predicted image selected by the processing in step S105. The difference data is smaller in data amount than the original image data. Accordingly, the data amount can be made smaller than in a case where images are directly encoded.

In step S107, the orthogonal transform unit 104 performs an orthogonal transform on the difference information generated by the processing in step S106. Specifically, an orthogonal transform such as a discrete cosine transform or a Karhunen-Loeve transform is performed, and a transform coefficient is output.

In step S108, using the quantization parameter from the rate control unit 117, the quantization unit 105 quantizes the orthogonal transform coefficient obtained by the processing in step S107.

The difference information quantized by the processing in step S108 is locally decoded in the following manner. In step S109, the inverse quantization unit 108 inversely quantizes the quantized orthogonal transform coefficient (also referred to as the quantized coefficient) generated by the processing in step S108, using properties compatible with the properties of the quantization unit 105. In step S110, the inverse orthogonal transform unit 109 performs an inverse orthogonal transform on the orthogonal transform coefficient obtained by the processing in step S109, using properties compatible with the properties of the orthogonal transform unit 104.

In step S111, the arithmetic operation unit 110 adds the predicted image to the locally decoded difference information, and generates a locally decoded image (an image corresponding to the input to the arithmetic operation unit 103). In step S112, the deblocking filter 111 performs, where appropriate, a deblocking filtering process on the locally decoded image obtained by the processing in step S111.

In step S113, the frame memory 112 stores the decoded image subjected to the deblocking filtering process by the processing in step S112. It should be noted that images that have not been subjected to filtering processes by the deblocking filter 111 are also supplied from the arithmetic operation unit 110, and are stored into the frame memory 112.

In step S114, the lossless encoding unit 106 encodes the transform coefficient quantized by the processing in step S108. That is, lossless encoding such as variable-length encoding or arithmetic encoding is performed on the difference image.

At this point, the lossless encoding unit 106 also encodes the information about the prediction mode of the predicted image selected by the processing in step S105, and adds the encoded information to the encoded data obtained by encoding the difference image. Specifically, the lossless encoding unit 106 also encodes the optimum intra prediction mode information supplied from the intra prediction unit 114 or the information about the optimum inter prediction mode supplied from the motion prediction/compensation unit 115, and adds the encoded information to the encoded data.

If the predicted image in the inter prediction mode is selected by the processing in step S106, the information about the difference motion vector calculated in step S105 and a flag indicating the index of the predicted motion vector are also encoded.

In step S115, the accumulation buffer 107 accumulates the encoded data obtained by the processing in step S114. The encoded data accumulated in the accumulation buffer 107 is read where appropriate, and is transmitted to the decoding side via a transmission path or a recording medium.

In step S116, based on the bit rate (code generation amount) of the encoded data accumulated in the accumulation buffer 107 by the processing in step S115, the rate control unit 117 controls the quantization operation rate of the quantization unit 105 so as not to cause an overflow or underfloor.

When the processing in step S116 is completed, the encoding process comes to an end.

[Flow of the Inter Motion Prediction Process]

Referring now to the flowchart shown in FIG. 18, an example flow of the inter motion prediction process to be performed in step S104 in FIG. 17 is described.

In step S151, the motion prediction/compensation unit 115 performs a motion search in each inter prediction mode. Information about motion vector information obtained by the motion prediction/compensation unit 115 is supplied to the cost function value calculation unit 154.

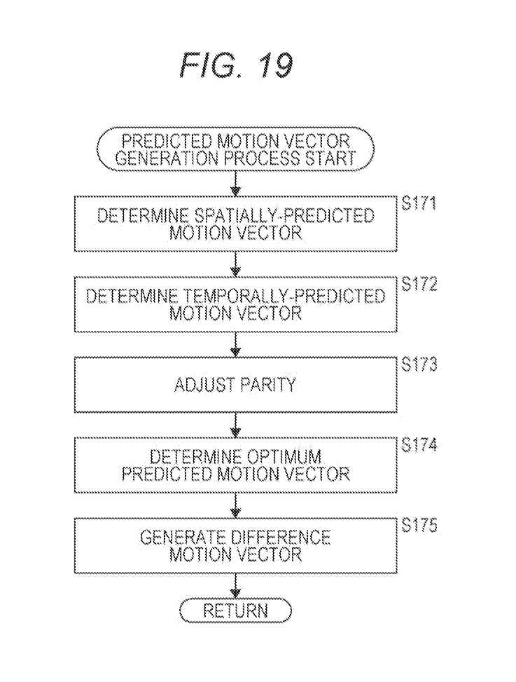

In step S152, according to a method using AMVP or the merge mode described above with reference to FIG. 7 or 9, the candidate predicted motion vector generation unit 153 generates predicted motion vectors as candidate predicted motion vectors of the current PU. The predicted motion vector generation process will be described later in detail, with reference to FIG. 19.

Through the process in step S152, a spatially-predicted motion vector as a candidate predicted motion vector of the current PU is generated by referencing the spatially-neighboring motion vector information supplied from the spatially-neighboring motion vector buffer 151. A temporally-predicted motion vector as a candidate predicted motion vector of the current PU is also generated by referencing the temporally-neighboring motion vector information supplied from the temporally-neighboring motion vector buffer 152, and shift adjustment is performed on the vertical component of the generated temporally-predicted motion vector.

Between the generated spatially-predicted motion vector and the adjusted temporally-predicted motion vector, the optimum one is determined to be the optimum predicted motion vector, and is supplied to the motion prediction/compensation unit 115. The motion prediction/compensation unit 115 then generates a difference motion vector that is the difference from the motion vector. In the case of the merge mode, the difference motion vector is not generated.

In step S153, the motion prediction/compensation unit 115 calculates cost function values with respect to the respective inter prediction modes by using the input image supplied from the screen rearrangement buffer 102, the generated difference motion vector information, and the like.

In step S154, the motion prediction/compensation unit 115 determines the optimum inter prediction mode to be the prediction mode with the smallest cost function value among the respective prediction modes. In step S155, the motion prediction/compensation unit 115 generates a predicted image in the optimum inter prediction mode, and supplies the predicted image to the predicted image selection unit 116.

In step S156, the motion prediction/compensation unit 115 supplies information about the optimum inter prediction mode to the lossless encoding unit 106, which then encodes the information about the optimum inter prediction mode.

The information about the optimum inter prediction mode includes optimum inter prediction mode information, the difference motion vector information in the optimum inter prediction mode, the reference picture information in the optimum inter prediction mode, and the information about the predicted motion vector. The information about the predicted motion vector includes a flag indicating the index of the predicted motion vector, for example.

In response to the processing in step S156, the supplied pieces of information are encoded in step S114 in FIG. 17.

[ Flow of the Predicted Motion Vector Generation Process]

Referring now to the flowchart shown in FIG. 19, the predicted motion vector generation process in step S152 in FIG. 18 is described.

In step S171, the candidate predicted motion vector generation unit 153 generates and determines a spatially-predicted motion vector as a candidate predicted motion vector of the current PU by referencing the spatially-neighboring motion vector information supplied from the spatially-neighboring motion vector buffer 151. The candidate predicted motion vector generation unit 153 supplies information about the determined spatially-predicted motion vector as candidate predicted motion vector information to the cost function value calculation unit 154.

In step S172, the candidate predicted motion vector generation unit 153 generates and determines a temporally-predicted motion vector as a candidate predicted motion vector of the current PU by referencing the temporally-neighboring motion vector information supplied from the temporally-neighboring motion vector buffer 152. The candidate predicted motion vector generation unit 153 supplies information about the determined temporally-predicted motion vector as pre-shifting temporally-predicted vector information to the motion vector shifting unit 162. At this point, the candidate predicted motion vector generation unit 153 supplies information about the parity relation represented by the motion vector of the current region (the current PU) and information about the parity relation represented by the determined temporally-predicted motion vector, as the parity information, to the field determination unit 161.

In step S173, the field determination unit 161 and the motion vector shifting unit 162 that constitute the parity adjustment unit 122 adjust the parity of the pre-shifting temporally-predicted vector information supplied from the candidate predicted motion vector generation unit 153.

Specifically, the field determination unit 161 receives, from the candidate predicted motion vector generation unit 153, the parity information containing the information indicating the parity relation between the current PU and its reference PU, and the information indicating the parity relation between the temporally-neighboring PU and its reference PU. The field determination unit 161 determines the field of each region based on the parity information, and calculates the amount of shift adjustment for the vertical component of the temporally-predicted motion vector in accordance with the parity information as shown in FIG. 15.

The field determination unit 161 controls the motion vector shifting unit 162, and shifts, by the calculated amount of shift adjustment, the vertical component of the pre-shifting temporally-predicted motion vector supplied from the candidate predicted motion vector generation unit 153. The motion vector shifting unit 162 supplies information indicating the post-shifting temporally-predicted motion vector to the candidate predicted motion vector generation unit 153.

In turn, the candidate predicted motion vector generation unit 153 supplies information about the post-shifting temporally-predicted motion vector as candidate predicted motion vector information to the cost function value calculation unit 154. The cost function value calculation unit 154 calculates cost function values with respect to the respective candidate predicted motion vectors, and supplies the calculated cost function values, as well as the candidate predicted motion vector information, to the optimum predicted motion vector determination unit 155.

In step S174, the optimum predicted motion vector determination unit 155 determines the optimum predicted motion vector among the candidate predicted motion vectors. Specifically, the optimum predicted motion vector determination unit 155 determines the optimum predicted motion vector for the current PU to be the candidate predicted motion vector with the smallest cost function value supplied from the cost function value calculation unit 154, and supplies the information to that effect to the motion prediction/compensation unit 115.

In step S175, using the information about the optimum predicted motion vector supplied from the optimum predicted motion vector determination unit 155, the motion prediction/compensation unit 115 generates a difference motion vector that is the difference from the motion vector.

FIG. 19 shows an example case using a method according to AMVP. In the case of the merge mode, difference motion vector information is not generated, and therefore, step S175 is skipped.

As described above, in the image encoding device 100, the phase of the vertical component of a temporally-predicted motion vector is shifted based on the information about the parity relation represented by the motion vector of the current region (the current PU) and the information about the parity relation represented by the determined temporally-predicted motion vector. Accordingly, in a case where an input image is an interlaced signal, the efficiency of prediction involving a temporally-predicted motion vector can be increased by using AMVP or the merge mode. As a result, encoding efficiency can be increased.

### 2. Second Embodiment

### Image Decoding Device

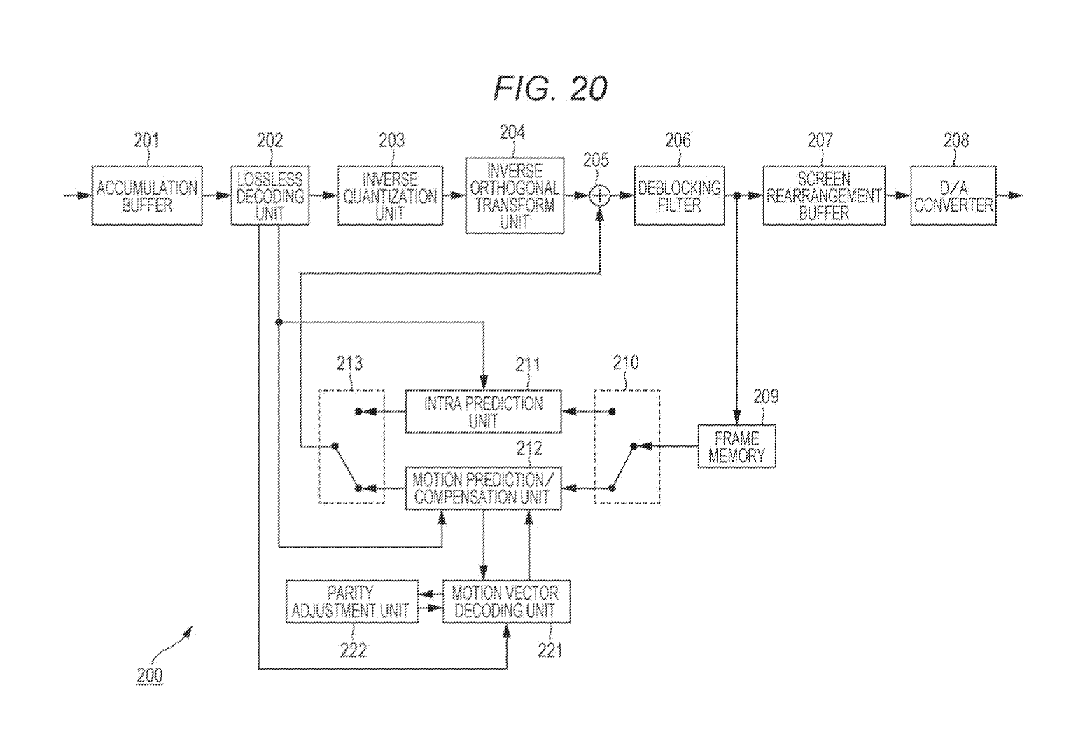

Next, decoding of encoded data (an encoded stream) that is encoded in the above described manner is described. FIG. 20 is a block diagram showing an example structure of an image decoding device compatible with the image encoding device 100 shown in FIG. 1.

The image decoding device 200 shown in FIG. 20 decodes encoded data generated by the image encoding device 100 by a decoding method compatible with the encoding method. Like the image encoding device 100, the image decoding device 200 performs inter predictions for each Prediction Unit (PU).

As shown in FIG. 20, the image decoding device 200 includes an accumulation buffer 201, a lossless decoding unit 202, an inverse quantization unit 203, an inverse orthogonal transform unit 204, an arithmetic operation unit 205, a deblocking filter 206, a screen rearrangement buffer 207, and a D/A converter 208. The image decoding device 200 also includes a frame memory 209, a selection unit 210, an intra prediction unit 211, a motion prediction/compensation unit 212, and a selection unit 213.

The image decoding device 200 further includes a motion vector decoding unit 221 and a parity adjustment unit 222.

The accumulation buffer 201 also serves as a reception unit that receives transmitted encoded data. The accumulation buffer 201 receives and accumulates encoded data that is transmitted thereto, and supplies the encoded data to the lossless decoding unit 202 at a predetermined time. Information necessary for decoding, such as prediction mode information, motion vector difference information, and predicted motion vector information, is added to the encoded data. The lossless decoding unit 202 decodes information that has been encoded by the lossless encoding unit 106 shown in FIG. 1 and has been supplied from the accumulation buffer 201, by a method compatible with the encoding method used by the lossless encoding unit 106. The lossless decoding unit 202 supplies quantized coefficient data of the difference image obtained as a result of the decoding, to the inverse quantization unit 203.

The lossless decoding unit 202 also determines whether an intra prediction mode has been selected as the optimum prediction mode and whether an inter prediction mode has been selected as the optimum prediction mode. The lossless decoding unit 202 supplies the information about the optimum prediction mode to the intra prediction unit 211 or the motion prediction/compensation unit 212, whichever is compatible with the selected mode. In a case where an inter prediction mode has been selected as the optimum prediction mode in the image encoding device 100, for example, information about the optimum prediction mode is supplied to the motion prediction/compensation unit 212.

The inverse quantization unit 203 inversely quantizes the quantized coefficient data obtained through the decoding by the lossless decoding unit 202, by a method compatible with the quantization method used by the quantization unit 105 shown in FIG. 1, and supplies the obtained coefficient data to the inverse orthogonal transform unit 204.

The inverse orthogonal transform unit 204 performs an inverse orthogonal transform on the coefficient data supplied from the inverse quantization unit 203, by a method compatible with the orthogonal transform method used by the orthogonal transform unit 104 shown in FIG. 1. Through this inverse orthogonal transform process, the inverse orthogonal transform unit 204 obtains decoded residual error data equivalent to the residual error data yet to be subjected to the orthogonal transform in the image encoding device 100.

The decoded residual error data obtained through the inverse orthogonal transform is supplied to the arithmetic operation unit 205. A predicted image is also supplied to the arithmetic operation unit 205 from the intra prediction unit 211 or the motion prediction/compensation unit 212 via the selection unit 213.

The arithmetic operation unit 205 adds the decoded residual error data to the predicted image, and obtains decoded image data corresponding to the image data yet to be subjected to the predicted image subtraction performed by the arithmetic operation unit 103 of the image encoding device 100. The arithmetic operation unit 205 supplies the decoded image data to the deblocking filter 206.

The deblocking filter 206 performs a deblocking filtering process on the supplied decoded image as appropriate, and supplies the image to the screen rearrangement buffer 207. For example, the deblocking filter 206, the loop filter 206, removes block distortion from the decoded image by performing the deblocking filtering process on the decoded image.

The deblocking filter 206 supplies the filtering process result (the decoded image subjected to the filtering process) to the screen rearrangement buffer 207 and the frame memory 209. The decoded image that is output from the arithmetic operation unit 205 can be supplied to the screen rearrangement buffer 207 and the frame memory 209 without passing through the deblocking filter 206. That is, the filtering process by the deblocking filter 206 can be skipped.

The screen rearrangement buffer 207 performs image rearrangement. Specifically, the frame sequence rearranged in the encoding order by the screen rearrangement buffer 102 shown in FIG. 1 is rearranged in the original displaying order. The D/A converter 208 performs a D/A conversion on the image supplied from the screen rearrangement buffer 207, and outputs the converted image to a display (not shown) to display the image.

The frame memory 209 stores the supplied decoded image, and supplies the stored decoded image as a reference image to the selection unit 210 at a predetermined time or in response to an external request from the intra prediction unit 211 or the motion prediction/compensation unit 212 or the like.

The selection unit 210 selects a supply destination of the reference image supplied from the frame memory 209. When an intra-encoded image is decoded, the selection unit 210 supplies the reference image supplied from the frame memory 209, to the intra prediction unit 211. When an inter-encoded image is decoded, the selection unit 210 supplies the reference image supplied from the frame memory 209, to the motion prediction/compensation unit 212.

Information that has been obtained by decoding the header information and indicates an intra prediction mode or the like is supplied, where appropriate, from the lossless decoding unit 202 to the intra prediction unit 211. The intra prediction unit 211 performs an intra prediction in the intra prediction mode used by the intra prediction unit 114 shown in FIG. 1, by using the reference image acquired from the frame memory 209. A predicted image is thus generated. The intra prediction unit 211 supplies the generated predicted image to the selection unit 213.

The motion prediction/compensation unit 212 acquires, from the lossless decoding unit 202, the information obtained by decoding the header information (optimum prediction mode information, reference image information, and the like).

The motion prediction/compensation unit 212 performs an inter prediction in the inter prediction mode indicated by the optimum prediction mode information acquired from the lossless decoding unit 202, using the reference image acquired from the frame memory 209. A predicted image is thus generated. At this point, the motion prediction/compensation unit 212 performs the inter prediction, using motion vector information reconstructed by the motion vector decoding unit 221.

The selection unit 213 supplies the predicted image supplied from the intra prediction unit 211 or the predicted image supplied from the motion prediction/compensation unit 212, to the arithmetic operation unit 205. The arithmetic operation unit 205 then adds the predicted image generated by using motion vectors to the decoded residual error data (difference image information) supplied from the inverse orthogonal transform unit 204, to obtain the original image. In other words, the motion prediction/compensation unit 212, the lossless decoding unit 202, the inverse quantization unit 203, the inverse orthogonal transform unit 204, and the arithmetic operation unit 205 serve as a decoding unit that decodes encoded data by using motion vectors, and generates the original image.

The motion vector decoding unit 221 acquires, from the lossless decoding unit 202, information about the index of the predicted motion vector and information about the difference motion vector among the pieces of the information obtained by decoding the header information. Here, the index of the predicted motion vector is information indicating which neighboring region has its motion vector used in the motion vector prediction process (predicted motion vector generation) for each PU, among the neighboring regions that are temporally adjacent to the current PU. The information about the difference motion vector is information indicating the value of the difference motion vector.

Using the motion vector of the neighboring PU indicated by the index of the predicted motion vector, the motion vector decoding unit 221 reconstructs the predicted motion vector. When the predicted motion vector is a spatially-predicted motion vector, the motion vector decoding unit 221 reconstructs the motion vector by adding the reconstructed predicted motion vector and the difference motion vector supplied from the lossless decoding unit 202.

When the predicted motion vector is a temporally-predicted motion vector, the motion vector decoding unit 221 supplies information about the reconstructed temporally-predicted motion vector as pre-shifting temporally-predicted vector information to the parity adjustment unit 122. At this point, the motion vector decoding unit 221 supplies information indicating the parity relation represented by the motion vector of the current region and the parity relation represented by the motion vector of the temporally-neighboring region (or the temporally-predicted motion vector) to the parity adjustment unit 122. In response to those supplies, the temporally-predicted motion vector subjected to shift adjustment is supplied from the parity adjustment unit 222. Accordingly, the motion vector decoding unit 221 reconstructs the motion vector by adding the post-shifting temporally-predicted motion vector supplied from the parity adjustment unit 122 and the difference motion vector supplied from the lossless decoding unit 202.

By referencing the parity-related information supplied from the motion vector decoding unit 221, the parity adjustment unit 222 performs shift adjustment on the vertical component of the temporally-predicted motion vector in accordance with the parity relation indicated by the motion vector information about the current region and the parity relation indicated by the motion vector information about the temporally-neighboring region. The parity adjustment unit 222 supplies the temporally-predicted motion vector subjected to the shift adjustment, to the motion vector decoding unit 221.

The fundamental operating principles related to the present technique in the motion vector decoding unit 221 and the parity adjustment unit 222 are the same as those in the motion vector encoding unit 121 and the parity adjustment unit 122 shown in FIG. 1. In the image encoding device 100 shown in FIG. 1, however, the method according to the present technique is implemented when a temporally-predicted motion vector is used in generated a candidate predicted motion vector, and the motion vector information about the current PU and the predicted motion vector information indicate different parities.

In the image decoding device 200 shown in FIG. 20, on the other hand, information indicating what kind of predicted motion vector has been determined for the current PU is transmitted from the encoding side. The method according to the present technique is implemented when a temporally-predicted motion vector has been used in the encoding, and the motion vector information about the current

PU and the predicted motion vector information indicate different parities.

[Example Structures of the Motion Vector Decoding Unit and the Parity Adjustment Unit]

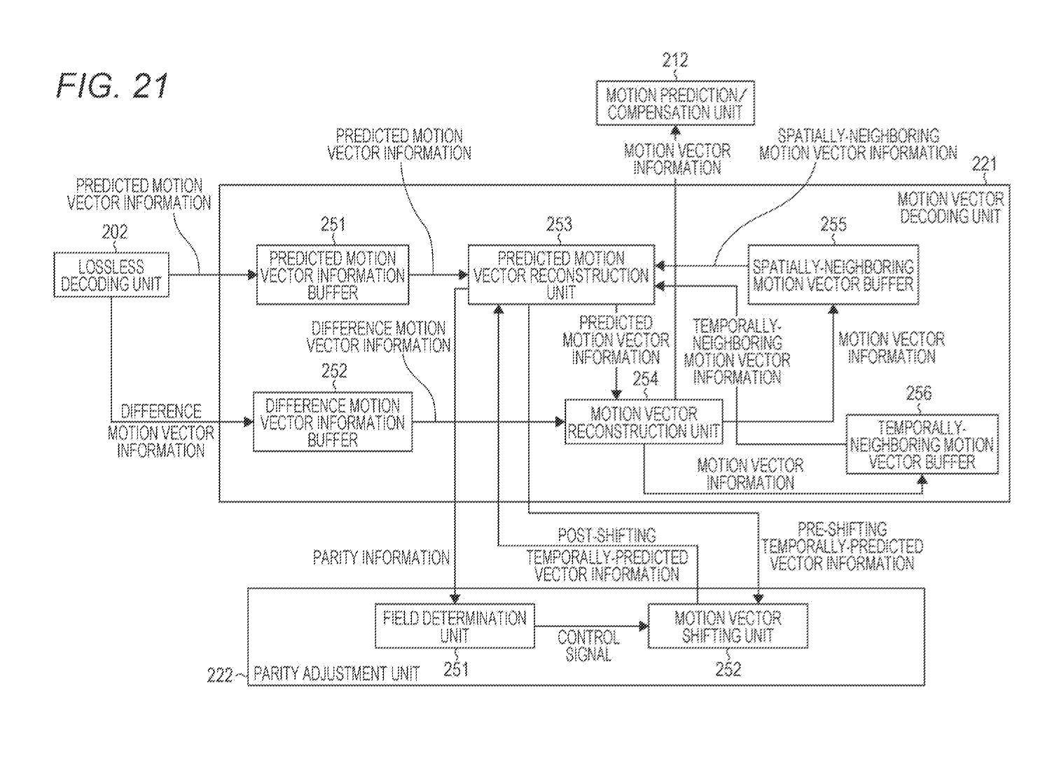

FIG. 21 is a block diagram showing typical example structures of the motion vector decoding unit 221 and the parity adjustment unit 222.

In the example shown in FIG. 21, the motion vector decoding unit 221 is designed to include a predicted motion vector information buffer 251, a difference motion vector information buffer 252, a predicted motion vector reconstruction unit 253, and a motion vector reconstruction unit 254. The motion vector decoding unit 221 is designed to further include a spatially-neighboring motion vector buffer 255 and a temporally-neighboring motion vector buffer 256.

The parity adjustment unit 222 is designed to include a field determination unit 261 and a motion vector shifting unit 262.

The predicted motion vector information buffer 251 stores information that has been decoded by the lossless decoding unit 202 and contains the index of the predicted motion vector of the current region (PU) (hereinafter referred to as the predicted motion vector information). The predicted motion vector information buffer 251 reads the predicted motion vector information about the current PU, and supplies the read information to the predicted motion vector reconstruction unit 253.

The difference motion vector information buffer 252 stores the difference motion vector information about the current region (PU) that has been decoded by the lossless decoding unit 202. The difference motion vector information buffer 252 reads the difference motion vector information about the current PU, and supplies the read information to the motion vector reconstruction unit 254.

The predicted motion vector reconstruction unit 253 determines whether the predicted motion vector of the current PU indicated by the information supplied from the predicted motion vector information buffer 251 is a spatially-predicted motion vector or is a temporally-predicted motion vector.

When the predicted motion vector of the current PU is a spatially-predicted motion vector, the predicted motion vector reconstruction unit 253 reads the information about the spatially-neighboring motion vector spatially adjacent to the current PU from the spatially-neighboring motion vector buffer 255. Using the read spatially-neighboring motion vector information, the predicted motion vector reconstruction unit 253 generates and reconstructs the predicted motion vector of the current PU according to a method using AMVP or the merge mode. The predicted motion vector reconstruction unit 253 supplies information about the reconstructed predicted motion vector to the motion vector reconstruction unit 254.

When the predicted motion vector of the current PU is a temporally-predicted motion vector, the predicted motion vector reconstruction unit 253 reads the information about the temporally-neighboring motion vector temporally adjacent to the current PU from the temporally-neighboring motion vector buffer 256. Using the read temporally-neighboring motion vector information, the predicted motion vector reconstruction unit 253 generates and reconstructs the predicted motion vector of the current PU according to a method using AMVP or the merge mode.

In the case of a temporally-predicted motion vector, the predicted motion vector reconstruction unit 253 further supplies information about the reconstructed predicted motion vector as the pre-shifting predicted vector information to the motion vector shifting unit 262. At this point, the predicted motion vector reconstruction unit 253 supplies parity information about the current PU and its reference PU, and parity information about the temporally-neighboring PU and its reference PU, to the field determination unit 161. The predicted motion vector reconstruction unit 253 supplies the information indicating the post-shifting temporally-predicted motion vector supplied from the motion vector shifting unit 262, as the predicted motion vector information, to the motion vector reconstruction unit 254.

The motion vector reconstruction unit 254 reconstructs the motion vector by adding the difference motion vector of the current PU indicated by the information supplied from the difference motion vector information buffer 252 and the predicted motion vector of the current PU supplied from the predicted motion vector reconstruction unit 253. The motion vector reconstruction unit 254 supplies information about the reconstructed motion vector to the motion prediction/compensation unit 212, the spatially-neighboring motion vector buffer 255, and the temporally-neighboring motion vector buffer 256.

Like the spatially-neighboring motion vector buffer 151 shown in FIG. 16, the spatially-neighboring motion vector buffer 255 is formed with a line buffer. The spatially-neighboring motion vector buffer 255 stores the motion vector information reconstructed by the motion vector reconstruction unit 254 as the spatially-neighboring motion vector information for the predicted motion vector information about the later PUs in the same picture.

Like the temporally-neighboring motion vector buffer 152 shown in FIG. 16, the temporally-neighboring motion vector buffer 256 is formed with a memory. The temporally-neighboring motion vector buffer 256 stores the motion vector information reconstructed by the motion vector reconstruction unit 254 as the temporally-neighboring motion vector information for the predicted motion vector information about the PUs in the other pictures.

Using the motion vector reconstructed by the motion vector reconstruction unit 254, the motion prediction/compensation unit 212 performs an inter prediction with a reference image in the inter prediction mode indicated by the optimum prediction mode information acquired from the lossless decoding unit 202, to generate a predicted image.

The field determination unit 261 receives, from the predicted motion vector reconstruction unit 253, parity information containing the information indicating the parity relation between the current PU and its reference PU, and the information indicating the parity relation between the temporally-neighboring PU and its reference PU. Based on the parity information, the field determination unit 261 determines the field of each region, and calculates the adjustment amount for the vertical component of the temporally-predicted motion vector in accordance with the two parity relations. The field determination unit 261 supplies a control signal containing the calculated adjustment amount to the motion vector shifting unit 262.

The motion vector shifting unit 262 receives information indicating the pre-shifting temporally-predicted motion vector from the predicted motion vector reconstruction unit 253. Based on the control signal from the field determination unit 261, the motion vector shifting unit 262 shifts the received temporally-predicted motion vector by an adjustment method shown in FIG. 15. The motion vector shifting unit 262 supplies information indicating the post-shifting temporally-predicted motion vector to the predicted motion vector reconstruction unit 253.

[Flow of a Decoding Process]

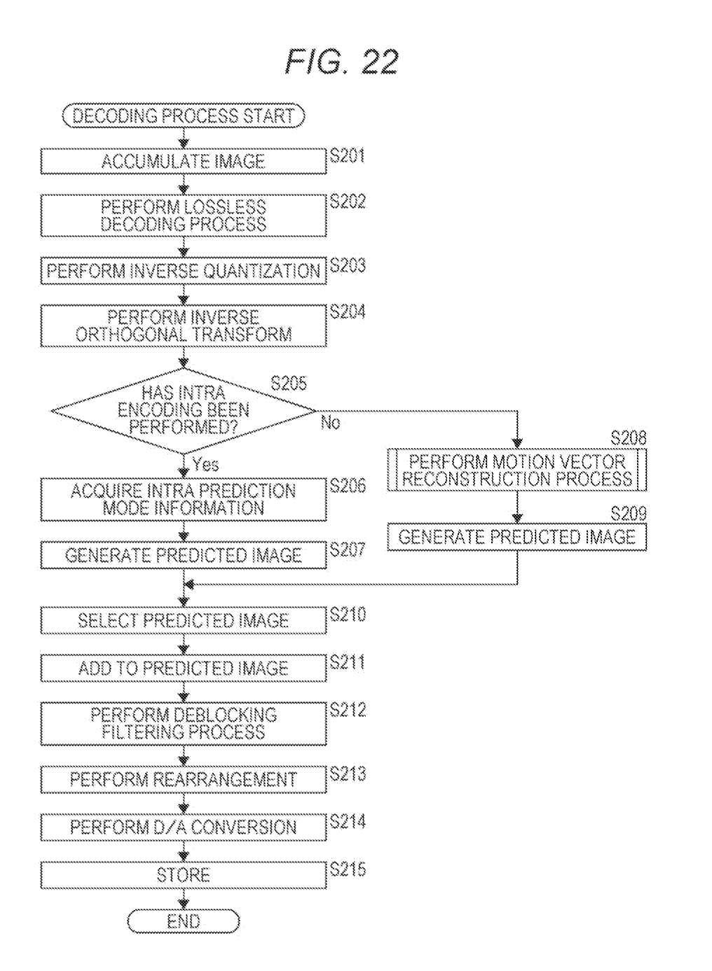

Next, the flow of each process to be performed by the above described image decoding device 200 is described. Referring first to the flowchart shown in FIG. 22, an example flow of a decoding process is described.

When the decoding process is started, the accumulation buffer 201 accumulates a transmitted encoded stream in step S201. In step S202, the lossless decoding unit 202 decodes the encoded stream (encoded difference image information) supplied from the accumulation buffer 201. Specifically, I-pictures, P-pictures, and B-pictures encoded by the lossless encoding unit 106 shown in FIG. 1 are decoded.

At this point, other than the difference image information, various kinds of information included in the code stream such as the header information are also decoded. The lossless decoding unit 202 acquires prediction mode information, difference motion vector information, information indicating the index of the predicted motion vector, and the like. The lossless decoding unit 202 supplies the acquired information to the corresponding units.

In step S203, the inverse quantization unit 203 inversely quantizes the quantized orthogonal transform coefficient obtained by the processing in step S202. In this inverse quantization process, the quantization parameter obtained by the later described processing in step S208 is used. In step S204, the inverse orthogonal transform unit 204 performs an inverse orthogonal transform on the orthogonal transform coefficient inversely quantized in step S203.

In step S205, based on the information about the optimum prediction mode decoded in step S202, the lossless decoding unit 202 determines whether the current encoded data has been intra-encoded. If the current encoded data is determined to have been intra-encoded, the process moves on to step S206.

In step S206, the intra prediction unit 211 acquires intra prediction mode information. In step S207, the intra prediction unit 211 performs an intra prediction by using the intra prediction mode information acquired in step S206, to generate a predicted image.

If the current encoded data is determined not to have been intra-encoded in step S206, or if the current encoded data is determined to have been inter-encoded, the process moves on to step S208.

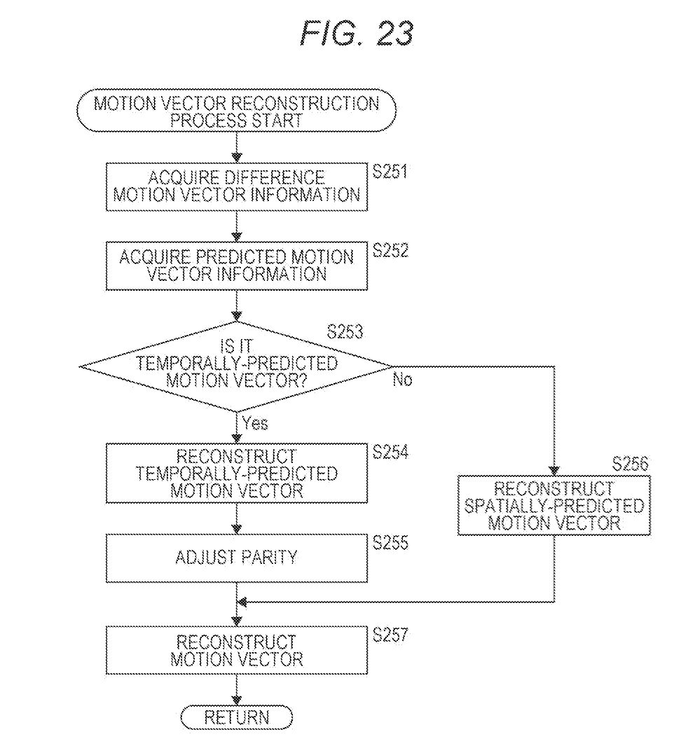

In step S208, the motion vector decoding unit 221 and the parity adjustment unit 222 perform a motion vector reconstruction process. This motion vector reconstruction process will be described later in detail, with reference to FIG. 23.

Through the process in step S208, the predicted motion vector of the current PU is reconstructed by referencing the decoded predicted motion vector information. When the predicted motion vector of the current PU is a temporally-predicted motion vector, shift adjustment is performed on the vertical component of the temporally-predicted motion vector in accordance with parity information. The motion vector is then reconstructed by using the predicted motion vector of the current PU subjected to reconstruction or shift adjustment, and the reconstructed motion vector is supplied to the motion prediction/compensation unit 212.

In step S209, the motion prediction/compensation unit 212 performs an inter motion prediction process by using the motion vector reconstructed by the processing in step S208, to generate a predicted image. The generated predicted image is supplied to the selection unit 213.

In step S210, the selection unit 213 selects the predicted image generated in step S207 or the predicted image generated in step S209. In step S211, the arithmetic operation unit 205 adds the predicted image selected in step S210 to the difference image information obtained through the inverse orthogonal transform in step S204. In this manner, the original image is decoded. Specifically, the original image is decoded by generating a predicted image with the use of the motion vector, and adding the generated predicted image to the difference image information supplied from the inverse orthogonal transform unit 204.

In step S212, the deblocking filter 206 performs, where appropriate, a deblocking filtering process on the decoded image obtained in step S211.

In step S213, the screen rearrangement buffer 207 rearranges the image subjected to the filtering process in step S212. Specifically, the order of frames rearranged for encoding by the screen rearrangement buffer 102 of the image encoding device 100 is rearranged in the original displaying order.

In step S214, the D/A converter 208 performs a D/A conversion on the image having the frame order rearranged in step S213. This image is output to a display (not shown), and is displayed.

In step S215, the frame memory 209 stores the image subjected to the filtering process in step S212.

When the processing in step S215 is completed, the decoding process comes to an end.

[Flow of the Motion Vector Reconstruction Process]

Referring now to the flowchart shown in FIG. 23, an example flow of the motion vector reconstruction process performed in step S208 in FIG. 22 is described. This motion vector reconstruction process is a process to decode a motion vector by using information that has been transmitted from the encoding side and been decoded by the lossless decoding unit 202.

In step S202 in FIG. 17, the lossless decoding unit 202 acquires decoded parameter information and the like, and supplies the acquired information to the corresponding units.

In step S251, the difference motion vector information buffer 252 acquires the difference motion vector information from the lossless decoding unit 202, and supplies the acquired information to the motion vector reconstruction unit 254.

In step S252, the predicted motion vector information buffer 251 acquires the predicted motion vector information from the lossless decoding unit 202, and supplies the acquired information to the predicted motion vector reconstruction unit 253.

In step S253, the predicted motion vector reconstruction unit 253 determines whether the predicted motion vector of the current PU is a temporally-predicted motion vector based on the information supplied from the predicted motion vector information buffer 251.

If the predicted motion vector of the current PU is determined to be a temporally-predicted motion vector in step S253, the process moves on to step S254. In step S254, using the temporally-neighboring motion vector information supplied from the temporally-neighboring motion vector buffer 256, the predicted motion vector reconstruction unit 253 generates and reconstructs the temporally-predicted motion vector of the current PU according to a method using AMVP or the merge mode. The predicted motion vector reconstruction unit 253 supplies information about the reconstructed temporally-predicted motion vector as pre-shifting temporally-predicted vector information to the motion vector shifting unit 262.

At this point, the predicted motion vector reconstruction unit 253 supplies parity information about the current PU and its reference PU, and parity information about the temporally-neighboring PU and its reference PU, to the field determination unit 261.

In step S255, the field determination unit 261 and the motion vector shifting unit 262 of the parity adjustment unit 222 adjust the parity of the pre-shifting temporally-predicted vector information supplied from the predicted motion vector reconstruction unit 253.

Specifically, the field determination unit 261 receives, from the predicted motion vector reconstruction unit 253, the parity information containing the information indicating the parity relation between the current PU and its reference PU, and the information indicating the parity relation between the temporally-neighboring PU and its reference PU. The field determination unit 261 determines the field of each region based on the parity information, and calculates the amount of shift adjustment for the vertical component of the temporally-predicted motion vector in accordance with the parity information as shown in FIG. 15.

The field determination unit 261 controls the motion vector shifting unit 262, and shifts, by the calculated amount of shift adjustment, the vertical component of the pre-shifting temporally-predicted motion vector supplied from the predicted motion vector reconstruction unit 253. The motion vector shifting unit 262 supplies information indicating the post-shifting temporally-predicted motion vector to the predicted motion vector reconstruction unit 253.

If the predicted motion vector of the current PU is determined not to be a temporally-predicted motion vector in step S253, on the other hand, the process moves on to step S256. In step S256, using the spatially-neighboring motion vector information supplied from the spatially-neighboring motion vector buffer 255, the predicted motion vector reconstruction unit 253 generates and reconstructs the spatially-predicted motion vector of the current PU according to a method using AMVP or the merge mode.

The temporally-predicted motion vector information subjected to parity adjustment in step S255 or the information about the spatially-predicted motion vector reconstructed in step S256 is supplied as the candidate predicted motion vector information to the motion vector reconstruction unit 254.

In step S257, the motion vector reconstruction unit 254 reconstructs the motion vector of the current PU.

Specifically, the motion vector reconstruction unit 254 reconstructs the motion vector by adding the difference motion vector of the current PU indicated by the information supplied from the difference motion vector information buffer 252 and the predicted motion vector of the current PU supplied from the predicted motion vector reconstruction unit 253. The motion vector reconstruction unit 254 supplies information indicating the reconstructed motion vector to the motion prediction/compensation unit 212, the spatially-neighboring motion vector buffer 255, and the temporally-neighboring motion vector buffer 256.

FIG. 23 shows a case using a method according to AMVP. In the case of the merge mode, difference motion vector information is not transmitted from the encoding side, and therefore, step S251 is skipped. Also, in the case of the merge mode, the predicted motion vector of the current PU supplied from the predicted motion vector reconstruction unit 253 is set as the motion vector of the current PU in step S257.

By performing the respective processes as described above, the image decoding device 200 can correctly decode encoded data that has been encoded by the image encoding device 100, and can realize higher encoding efficiency.

That is, in the image decoding device 200, the phase of the vertical component of a temporally-predicted motion vector is also shifted based on the information about the parity relation represented by the motion vector of the current region (the current PU) and the information about the parity relation represented by the determined temporally-predicted motion vector. Accordingly, in a case where an input image is an interlaced signal, the efficiency of prediction involving a temporally-predicted motion vector can be increased by using AMVP or the merge mode. As a result, encoding efficiency can be increased.

Although example cases compliant with HEVC have been described so far, the range of application of the present technique is not limited to examples compliant with HEVC. The present technique can be applied to devices that use other encoding methods, as long as the devices have inputs of interlaced signals, and perform encoding processes and decoding processes on motion vector information through MV competitions or in the merge mode.

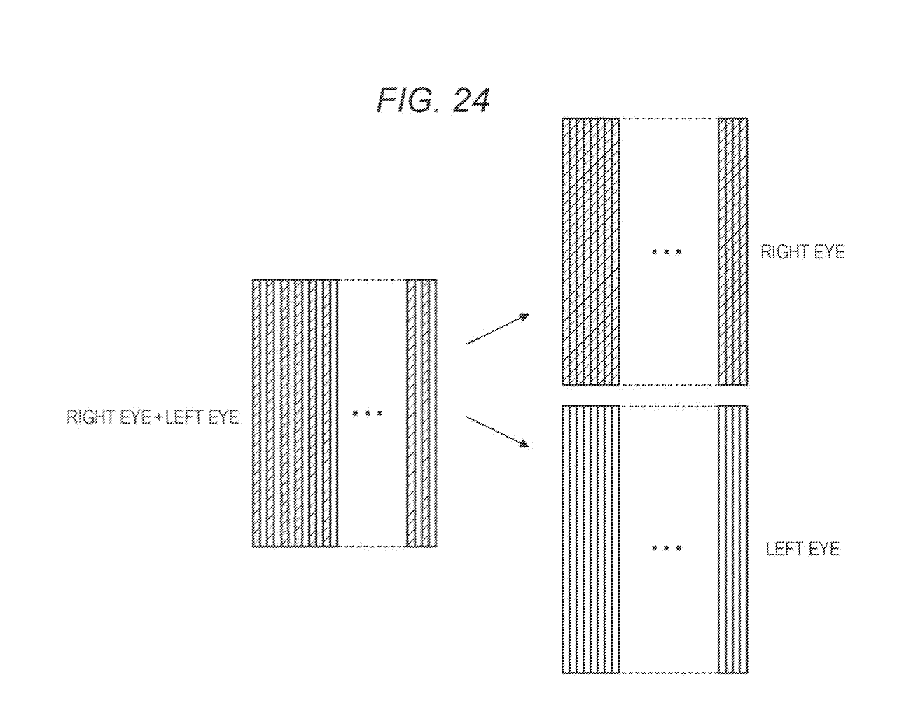

The range of application of the present technique is not limited to cases where an input is an interlaced signal. The above described present technique can also be applied to a multi-dimensional image signal as shown in FIG. 24, for example.

FIG. 24 shows an example of a multi-view image signal. In a multi-view image signal, a picture is formed alternately with right-eye views and left-eye views.

In the case of such a multi-view image signal, shift adjustment that is basically the same as that in the above described case with an interlaced signal is performed on the temporally-predicted motion vector, when the information about the views indicates that there is a difference between the view relation between the current PU and its reference PU, and the view relation between temporally-neighboring PU and its reference PU. However, while the shift adjustment in the case with an interlaced signal is performed on the vertical component of the temporally-predicted motion vector, the shift adjustment in the case with a multi-view image signal is performed on the horizontal component of the temporally-predicted motion vector.

The present technique can be applied to image encoding devices and image decoding devices that are used when image information (bit streams) compressed through orthogonal transforms such as discrete cosine transforms and motion compensation is received via a network medium such as satellite broadcasting, cable television, the Internet, or a portable telephone device, as in MPEG or H.26x, for example. The present technique can also be applied to image encoding devices and image decoding devices that are used when compressed image information is processed on a storage medium such as an optical or magnetic disk or a flash memory. Further, the present technique can be applied to motion prediction/compensation devices included in such image encoding devices and image decoding devices.

### 3. Third Embodiment

### Computer

The series of processes described above can be performed either by hardware or by software. When the series of processes are to be performed by software, the programs forming the software are installed into a computer. Here, the computer may be a computer incorporated into special-purpose hardware, or may be a general-purpose personal computer that can execute various kinds of functions as various kinds of programs are installed thereinto.

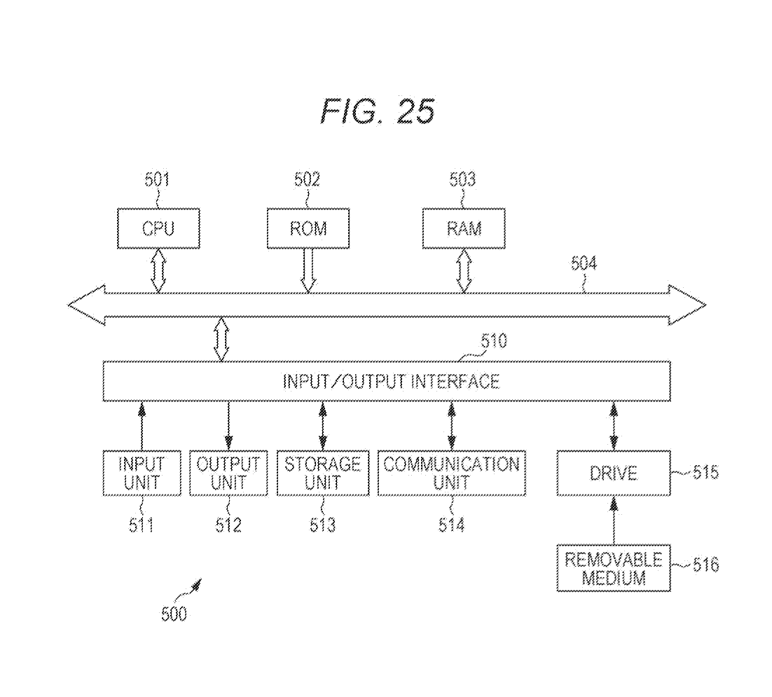

FIG. 25 is a block diagram showing an example structure of the hardware of a computer that performs the above described series of processes in accordance with a program.

In the computer 500, a CPU (Central Processing Unit) 501, a ROM (Read Only Memory) 502, and a RAM (Random Access Memory) 503 are connected to one another by a bus 504.

An input/output interface 505 is further connected to the bus 504. An input unit 506, an output unit 507, a storage unit 508, a communication unit 509, and a drive 510 are connected to the input/output interface 505.

The input unit 506 is formed with a keyboard, a mouse, a microphone, and the like. The output unit 507 is formed with a display, a speaker, and the like. The storage unit 508 is formed with a hard disk, a nonvolatile memory, or the like. The communication unit 509 is formed with a network interface or the like. The drive 510 drives a removable medium 511 such as a magnetic disk, an optical disk, a magnetooptical disk, or a semiconductor memory.

In the computer having the above described structure, the CPU 501 loads a program stored in the storage unit 508 into the RAM 503 via the input/output interface 505 and the bus 504, and executes the program, so that the above described series of processes are performed.

The programs to be executed by the computer 500 (the CPU 501) may be recorded on the removable medium 511 as a package medium to be provided, for example. Alternatively, the programs can be provided via a wired or wireless transmission medium such as a local area network, the Internet, or digital satellite broadcasting.

In the computer, the programs can be installed into the storage unit 508 via the input/output interface 505 when the removable medium 511 is mounted in the drive 510. The programs can also be received by the communication unit 509 via a wired or wireless transmission medium, and be installed into the storage unit 508. Alternatively, the programs may be installed beforehand into the ROM 502 or the storage unit 508.

The programs to be executed by the computer may be programs for performing processes in chronological order in accordance with the sequence described in this specification, or may be programs for performing processes in parallel or performing a process when necessary, such as when there is a call.

In this specification, the steps written in the programs recorded in a recording medium include not only processes to be performed in chronological order in accordance with the sequence described herein, but also processes to be performed in parallel or independently of one another if not necessarily in chronological order.

In this specification, a “system” means an entire apparatus formed with two or more devices (apparatuses).

Also, in the above described examples, any structure described as one device (or one processing unit) may be divided into two or more devices (or processing units). Conversely, any structure described as two or more devices (or processing units) may be combined to form one device (or one processing unit). Also, it is of course possible to add a structure other than the above described ones to the structure of any of the devices (or any of the processing units). Further, as long as the structure and function of the entire system remain the same, part of the structure of a device (or a processing unit) may be incorporated into another device (or another processing unit). That is, embodiments of the present technique are not limited to the above described embodiments, and various modifications may be made to them without departing from the scope of the technique.

The image encoding device and the image decoding device according to the above described embodiments can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. In the following, four example applications are described.

### 4. Example Applications

### First Example Application

### Television Receiver

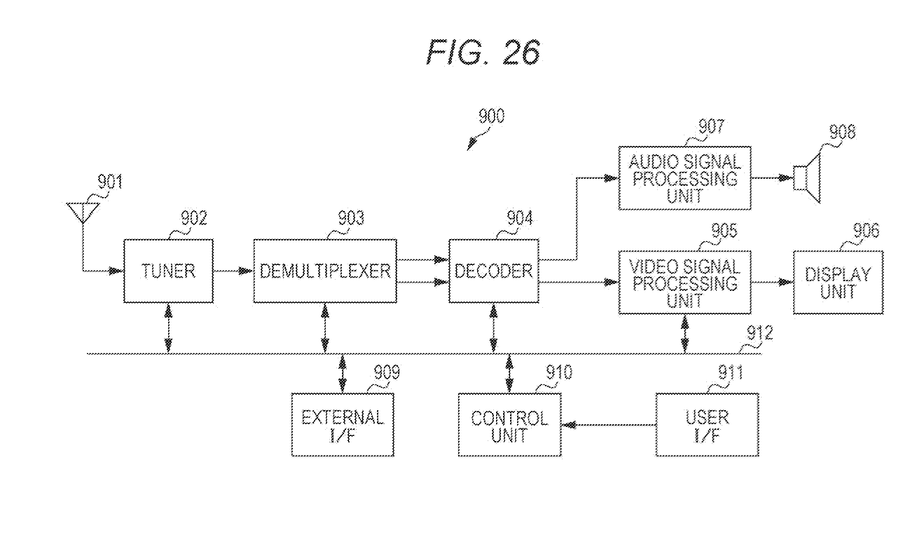

FIG. 26 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as a transmission means in the television apparatus 900 that receives encoded streams formed by encoding images.

The demultiplexer 903 separates the video stream and the audio stream of a show to be viewed from the encoded bit stream, and outputs the respective separated streams to the decoder 904. The demultiplexer 903 also extracts auxiliary data such as an EPG (Electronic Program Guide) from the encoded bit stream, and supplies the extracted data to the control unit 910. In a case where the encoded bit stream has been scrambled, the demultiplexer 903 may perform descrambling.

The decoder 904 decodes the video stream and the audio stream input from the demultiplexer 903. The decoder 904 then outputs the video data generated by the decoding process to the video signal processing unit 905. The decoder 904 also outputs the audio data generated by the decoding process to the audio signal processing unit 907.

The video signal processing unit 905 reproduces the video data input from the decoder 904, and causes the display unit 906 to display the video image. Also, the video signal processing unit 905 may cause the display unit 906 to display an application screen supplied via a network. Also, the video signal processing unit 905 may perform additional processing such as denoising on the video data in accordance with the settings. Further, the video signal processing unit 905 may generate an image of a GUI (Graphical User Interface) such as a menu and buttons or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an OELD (Organic ElectroLuminescence Display)).

The audio signal processing unit 907 performs a reproducing operation such as a D/A conversion and amplification on the audio data input from the decoder 904, and outputs sound from the speaker 908. Also, the audio signal processing unit 907 may perform additional processing such as denoising on the audio data.

The external interface 909 is an interface for connecting the television apparatus 900 to an external device or a network. For example, a video stream or an audio stream received via the external interface 909 may be decoded by the decoder 904. That is, the external interface 909 also serves as a transmission means in the television apparatus 900 that receives encoded streams formed by encoding images.

The control unit 910 includes a processor such as a CPU, and a memory such as a RAM or a ROM. The memory stores the program to be executed by the CPU, program data, EPG data, data acquired via networks, and the like. The program stored in the memory is read by the CPU at the time of activation of the television apparatus 900, for example, and is then executed. By executing the program, the CPU controls operations of the television apparatus 900 in accordance with an operating signal input from the user interface 911, for example.

The user interface 911 is connected to the control unit 910. The user interface 911 includes buttons and switches for the user to operate the television apparatus 900, and a reception unit for remote control signals, for example. The user interface 911 generates an operating signal by detecting an operation by the user via those components, and outputs the generated operating signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having the above described structure, the decoder 904 has the functions of the image decoding device according to the above described embodiments. Accordingly, when an image is decoded in the television apparatus 900, encoding efficiency can be increased in decoding a motion vector with respect to an interlaced signal.

### Second Example Application

### Portable Telephone Device

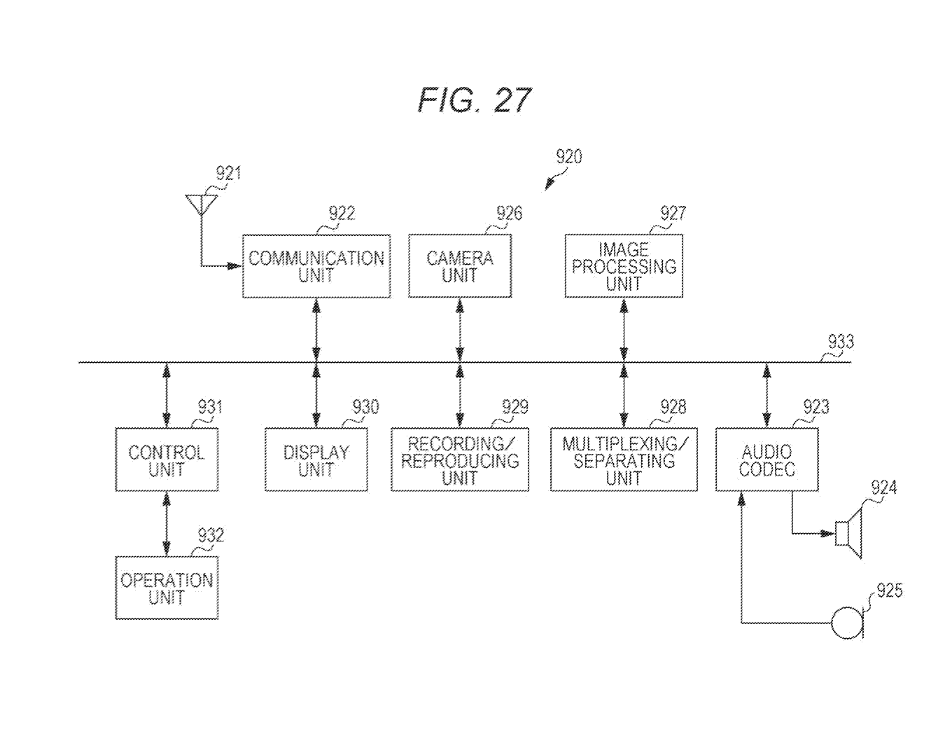

FIG. 27 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 generates audio data by demodulating and decoding the reception signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data constituting an electronic mail in accordance with an operation by the user via the operation unit 932. The control unit 931 causes the display unit 930 to display the text. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 then restores the electronic mail data by demodulating and decoding the reception signal, and outputs the restored electronic mail data to the control unit 931. The control unit 931 causes the display unit 930 to display the contents of the electronic mail, and stores the electronic mail data into the storage medium in the recording/reproducing unit 929.

The recording/reproducing unit 929 includes a readable/rewritable storage medium. For example, the storage medium may be an internal storage medium such as a RAM or a flash memory, or may be a storage medium of an externally mounted type such as a hard disk, a magnetic disk, a magnetooptical disk, an optical disk, a USB (Unallocated Space Bitmap) memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The transmission signal and the reception signal each include an encoded bit stream. The communication unit 922 restores a stream by demodulating and decoding the reception signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images are displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 920 having the above described structure, the image processing unit 927 has the functions of the image encoding device and the image decoding device according to the above described embodiments. Accordingly, when an image is encoded and decoded in the portable telephone device 920, encoding efficiency can be increased in encoding or decoding a motion vector in a case where an input is an interlaced signal.

### Third Example Application

### Recording/Reproducing Apparatus

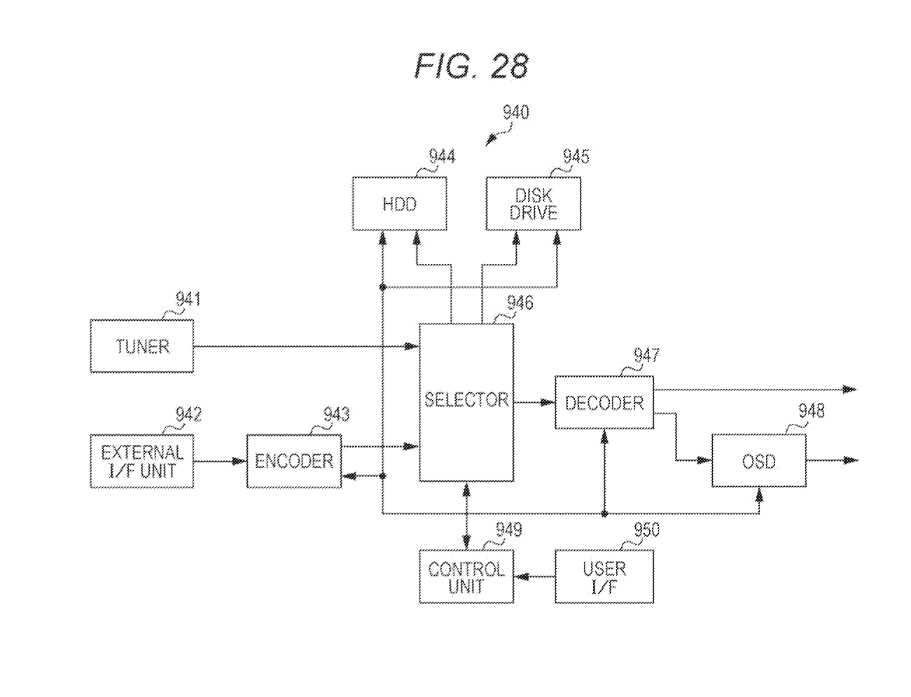

FIG. 28 schematically shows an example structure of a recording/reproducing apparatus to which the above described embodiments are applied. A recording/reproducing apparatus 940 encodes audio data and video data of a received broadcast show, for example, and records the audio data and the video data on a recording medium. The recording/reproducing apparatus 940 may encode audio data and video data acquired from another apparatus, for example, and record the audio data and the video data on the recording medium. The recording/reproducing apparatus 940 also reproduces data recorded on the recording medium through a monitor and a speaker in accordance with an instruction from the user, for example. In doing so, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from broadcast signals received via an antenna (not shown), and demodulates the extracted signal. The tuner 941 outputs the encoded bit stream obtained by the demodulation to the selector 946. That is, the tuner 941 serves as a transmission means in the recording/reproducing apparatus 940.

The external interface 942 is an interface for connecting the recording/reproducing apparatus 940 to an external device or a network. The external interface 942 may be an IEEE1394 interface, a network interface, a USB interface, or a flash memory interface, for example. Video data and audio data received via the external interface 942 are input to the encoder 943, for example. That is, the external interface 942 serves as a transmission means in the recording/reproducing apparatus 940.

In a case where video data and audio data input from the external interface 942 have not been encoded, the encoder 943 encodes the video data and the audio data. The encoder 943 then outputs an encoded bit stream to the selector 946.

The HDD 944 records an encoded bit stream formed by compressing content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (a registered trade name) disk, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD 948. The decoder 904 also outputs the generated audio data to an external speaker.

The OSD 948 reproduces the video data input from the decoder 947, and displays video images. The OSD 948 may superimpose an image of a GUI such as a menu and buttons or a cursor on the video images to be displayed.

The control unit 949 includes a processor such as a CPU, and a memory such as a RAM or a ROM. The memory stores the program to be executed by the CPU, program data, and the like. The program stored in the memory is read by the CPU at the time of activation of the recording/reproducing apparatus 940, for example, and is then executed. By executing the program, the CPU controls operations of the recording/reproducing apparatus 940 in accordance with an operating signal input from the user interface 950, for example.

The user interface 950 is connected to the control unit 949. The user interface 950 includes buttons and switches for the user to operate the recording/reproducing apparatus 940, and a reception unit for remote control signals, for example. The user interface 950 generates an operating signal by detecting an operation by the user via those components, and outputs the generated operating signal to the control unit 949.

In the recording/reproducing apparatus 940 having the above described structure, the encoder 943 has the functions of the image encoding device according to the above described embodiments. Also, the decoder 947 has the functions of the image decoding device according to the above described embodiments. Accordingly, when an image is encoded and decoded in the recording/reproducing apparatus 940, encoding efficiency can be increased in encoding or decoding a motion vector in a case where an input is an interlaced signal.

### Fourth Example Application

### Imaging Apparatus

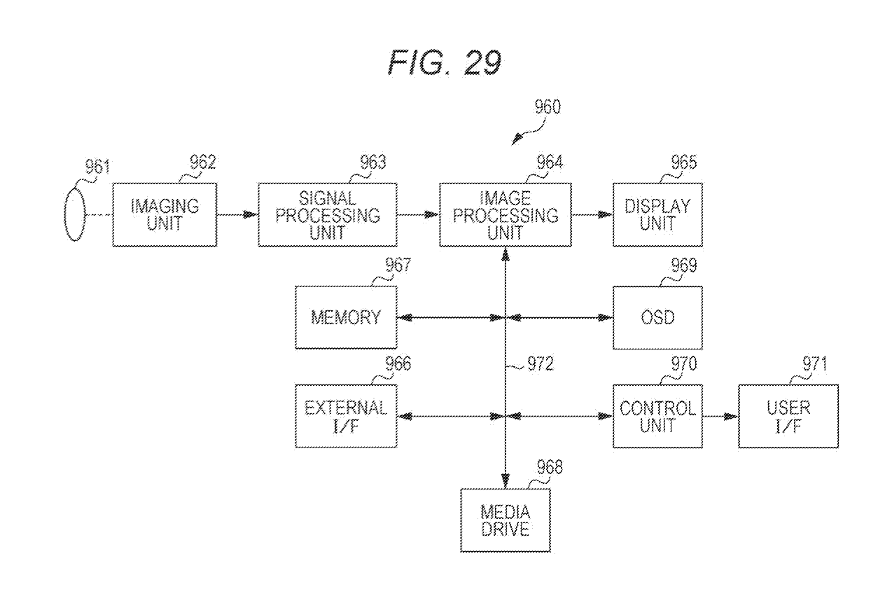

FIG. 29 schematically shows an example structure of an imaging apparatus to which the above described embodiments are applied. An imaging apparatus 960 generates images by imaging an object, encodes the image data, and records the image data on a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens and a diaphragm. The optical block 961 forms an optical image of an object on the imaging surface of the imaging unit 962. The imaging unit 962 includes an image sensor such as a CCD (Charge Coupled Device) or a CMOS (Complementary Metal Oxide Semiconductor), and converts the optical image formed on the imaging surface into an image signal as an electrical signal by a photoelectric conversion. The imaging unit 962 outputs the image signal to the signal processing unit 963.

The signal processing unit 963 performs various kinds of camera signal processing such as a knee correction, a gamma correction, and a color correction on the image signal input from the imaging unit 962. The signal processing unit 963 outputs the image data subjected to the camera signal processing to the image processing unit 964.

The image processing unit 964 encodes the image data input from the signal processing unit 963, and generates encoded data. The image processing unit 964 outputs the generated encoded data to the external interface 966 or the media drive 968. The image processing unit 964 also decodes encoded data input from the external interface 966 or the media drive 968, and generates image data. The image processing unit 964 outputs the generated image data to the display unit 965. Alternatively, the image processing unit 964 may output the image data input from the signal processing unit 963 to the display unit 965 to display images. The image processing unit 964 may also superimpose display data acquired from the OSD 969 on the images to be output to the display unit 965.

The OSD 969 generates an image of a GUI such as a menu and buttons or a cursor, for example, and outputs the generated image to the image processing unit 964.

The external interface 966 is formed as a USB input/output terminal, for example. The external interface 966 connects the imaging apparatus 960 to a printer at the time of printing of an image, for example. A drive is also connected to the external interface 966, if necessary. A removable medium such as a magnetic disk or an optical disk is mounted on the drive so that a program read from the removable medium can be installed into the imaging apparatus 960. Further, the external interface 966 may be designed as a network interface to be connected to a network such as a LAN or the Internet. That is, the external interface 966 serves as a transmission means in the imaging apparatus 960.

A recording medium to be mounted on the media drive 968 may be a readable/rewritable removable medium such as a magnetic disk, a magnetooptical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM or a ROM. The memory stores the program to be executed by the CPU, program data, and the like. The program stored in the memory is read by the CPU at the time of activation of the imaging apparatus 960, for example, and is then executed. By executing the program, the CPU controls operations of the imaging apparatus 960 in accordance with an operating signal input from the user interface 971, for example.

The user interface 971 is connected to the control unit 970. The user interface 971 includes buttons and switches for the user to operate the imaging apparatus 960, for example. The user interface 971 generates an operating signal by detecting an operation by the user via those components, and outputs the generated operating signal to the control unit 970.

In the imaging apparatus 960 having the above described structure, the image processing unit 964 has the functions of the image encoding device and the image decoding device according to the above described embodiments. Accordingly, when an image is encoded and decoded in the imaging apparatus 960, encoding efficiency can be increased in encoding or decoding a motion vector in a case where an input is an interlaced signal.

In this specification, various kinds of information, such as the code number of a predicted motion vector, difference motion vector information, and predicted motion vector information, are multiplexed with an encoded stream, and are transmitted from the encoding side to the decoding side, as described so far. However, the method of transmitting the information is not limited to the above example. The information may not be multiplexed with an encoded bit stream, but may be transmitted or recorded as independent data associated with an encoded bit stream. Here, the term “associate” means to link an image (or part of an image, such as a slice or a block) included in a bit stream to the information corresponding to the image at the time of decoding. In other words, the information may be transmitted through a different transmission path from images (or bit streams). Also, the information may be recorded on a different recording medium (or a different recording area in the same recording medium) from images (or bit streams). Further, each piece of the information may be associated with frames, one frame, or part of a frame of images (or bit streams).

Although preferred embodiments of this disclosure have been described above with reference to the accompanying drawings, this disclosure is not limited to those examples. It should be apparent to those who have ordinary skills in the art can make various changes or modifications within the scope of the technical spirit claimed herein, and it is naturally considered that those changes or modifications are within the technical scope of this disclosure.

The present technique can also be in the following forms.

(1) An image processing device including:

a predicted motion vector generation unit that generates the temporally-predicted motion vector of the predicted motion vectors to be used in decoding the motion vector of the current region in an image of an interlaced signal, by using the motion vector of a temporally-adjacent region that is located temporally adjacent to the current region;

a parity adjustment unit that performs shift adjustment on the vertical component of the temporally-predicted motion vector generated by the predicted motion vector generation unit, in accordance with the parity relation between the current region and the current reference region to be referenced by the motion vector of the current region, and the parity relation between the temporally-adjacent region and the adjacent reference region to be referenced by the motion vector of the temporally-adjacent region; and

a motion vector decoding unit that decodes the motion vector of the current region by using the temporally-predicted motion vector having the vertical component subjected to the shift adjustment by the parity adjustment unit.

(2) The image processing device of (1), wherein, when the phase shifting indicated by the parity relation between the current region and the current reference region differs from the phase shifting indicated by the parity relation between the temporally-adjacent region and the adjacent reference region, the parity adjustment unit performs shift adjustment on the vertical component of the temporally-predicted motion vector generated by the predicted motion vector generation unit.

(3) The image processing device of (2), wherein, when the phase shifting indicated by the parity relation between the current region and the current reference region is the opposite of the phase shifting indicated by the parity relation between the temporally-adjacent region and the adjacent reference region, the parity adjustment unit performs 1 or −1 shift adjustment on the vertical component of the temporally-predicted motion vector generated by the predicted motion vector generation unit.

(4) The image processing device of (3), wherein, when the parity relation between the current region and the current reference region is “BT” while the parity relation between the temporally-adjacent region and the adjacent reference region is “TB”, the parity adjustment unit performs 1 shift adjustment on the vertical component of the temporally-predicted motion vector generated by the predicted motion vector generation unit.

(5) The image processing device of (2), wherein, when only one of the parity relation between the current region and the current reference region, and the parity relation between the temporally-adjacent region and the adjacent reference region indicates phase shifting, and the other one of the parity relations indicates no phase shifting, the parity adjustment unit performs ½ or −½ shift adjustment on the vertical component of the temporally-predicted motion vector generated by the predicted motion vector generation unit.

(6) The image processing device of (5), wherein, when the parity relation between the current region and the current reference region is “TT” while the parity relation between the temporally-adjacent region and the adjacent reference region is “BT”, the parity adjustment unit performs ½ shift adjustment on the vertical component of the temporally-predicted motion vector generated by the predicted motion vector generation unit.

(7) The image processing device of any of (1) through (6), wherein the motion vector decoding unit decodes the motion vector of the current region by using the temporally-predicted motion vector having the vertical component subjected to the shift adjustment by the parity adjustment unit based on Advanced Motion Vector Prediction.

(8) The image processing device of any of (1) through (6), wherein the motion vector decoding unit decodes the motion vector of the current region by using the temporally-predicted motion vector having the vertical component subjected to the shift adjustment by the parity adjustment unit based on Motion Partition Merging.

(9) An image processing method including:

generating the temporally-predicted motion vector of the predicted motion vectors to be used in decoding the motion vector of the current region in an image of an interlaced signal, by using the motion vector of a temporally-adjacent region that is located temporally adjacent to the current region;

performing shift adjustment on the vertical component of the generated temporally-predicted motion vector, in accordance with the parity relation between the current region and the current reference region to be referenced by the motion vector of the current region, and the parity relation between the temporally-adjacent region and the adjacent reference region to be referenced by the motion vector of the temporally-adjacent region; and

decoding the motion vector of the current region by using the temporally-predicted motion vector having the vertical component subjected to the shift adjustment,

an image processing device generating the temporally-predicted motion vector, performing the shift adjustment, and decoding the motion vector of the current region.

(10) An image processing device including:

a predicted motion vector generation unit that generates the temporally-predicted motion vector of the predicted motion vectors to be used in encoding the motion vector of the current region in an image of an interlaced signal, by using the motion vector of a temporally-adjacent region that is located temporally adjacent to the current region;

a parity adjustment unit that performs shift adjustment on the vertical component of the temporally-predicted motion vector generated by the predicted motion vector generation unit, in accordance with the parity relation between the current region and the current reference region to be referenced by the motion vector of the current region, and the parity relation between the temporally-adjacent region and the adjacent reference region to be referenced by the motion vector of the temporally-adjacent region; and

a motion vector encoding unit that encodes the motion vector of the current region by using the temporally-predicted motion vector having the vertical component subjected to the shift adjustment by the parity adjustment unit.

(11) The image processing device of (10), wherein, when the phase shifting indicated by the parity relation between the current region and the current reference region differs from the phase shifting indicated by the parity relation between the temporally-adjacent region and the adjacent reference region, the parity adjustment unit performs shift adjustment on the vertical component of the temporally-predicted motion vector generated by the predicted motion vector generation unit.

(12) The image processing device of (11), wherein, when the phase shifting indicated by the parity relation between the current region and the current reference region is the opposite of the phase shifting indicated by the parity relation between the temporally-adjacent region and the adjacent reference region, the parity adjustment unit performs 1 or −1 shift adjustment on the vertical component of the temporally-predicted motion vector generated by the predicted motion vector generation unit.

(13) The image processing device of (12), wherein, when the parity relation between the current region and the current reference region is “BT” while the parity relation between the temporally-adjacent region and the adjacent reference region is “TB”, the parity adjustment unit performs 1 shift adjustment on the vertical component of the temporally-predicted motion vector generated by the predicted motion vector generation unit.

(14) The image processing device of (11), wherein, when only one of the parity relation between the current region and the current reference region, and the parity relation between the temporally-adjacent region and the adjacent reference region indicates phase shifting, and the other one of the parity relations indicates no phase shifting, the parity adjustment unit performs ½ or −½ shift adjustment on the vertical component of the temporally-predicted motion vector generated by the predicted motion vector generation unit.

(15) The image processing device of (14), wherein, when the parity relation between the current region and the current reference region is “TT” while the parity relation between the temporally-adjacent region and the adjacent reference region is “BT”, the parity adjustment unit performs ½ shift adjustment on the vertical component of the temporally-predicted motion vector generated by the predicted motion vector generation unit.

(16) The image processing device of any of (11) through (15), wherein the motion vector encoding unit encodes the motion vector of the current region by using the temporally-predicted motion vector having the vertical component subjected to the shift adjustment by the parity adjustment unit based on Advanced Motion Vector Prediction.

(17) The image processing device of any of (11) through (15), wherein the motion vector encoding unit encodes the motion vector of the current region by using the temporally-predicted motion vector having the vertical component subjected to the shift adjustment by the parity adjustment unit based on Motion Partition Merging.

(18) An image processing method including:

generating the temporally-predicted motion vector of the predicted motion vectors to be used in encoding the motion vector of the current region in an image of an interlaced signal, by using the motion vector of a temporally-adjacent region that is located temporally adjacent to the current region;

performing shift adjustment on the vertical component of the generated temporally-predicted motion vector, in accordance with the parity relation between the current region and the current reference region to be referenced by the motion vector of the current region, and the parity relation between the temporally-adjacent region and the adjacent reference region to be referenced by the motion vector of the temporally-adjacent region; and

encoding the motion vector of the current region by using the temporally-predicted motion vector having the vertical component subjected to the shift adjustment,

an image processing device generating the temporally-predicted motion vector, performing the shift adjustment, and encoding the motion vector of the current region.

### REFERENCE SIGNS LIST

100 Image encoding device
106 Lossless encoding unit
115 Motion prediction/compensation unit
121 Motion vector encoding unit
122 Parity adjustment unit
151 Spatially-neighboring motion vector buffer
152 Temporally-neighboring motion vector buffer
153 Candidate predicted motion vector generation unit
154 Cost function value calculation unit
155 Optimum predicted motion vector determination unit
161 Field determination unit
162 Motion vector shifting unit
200 Image decoding device
202 Lossless decoding unit
212 Motion prediction/compensation unit
221 Motion vector decoding unit
222 Parity adjustment unit
251 Predicted motion vector information buffer
252 Difference motion vector information buffer
253 Predicted motion vector reconstruction unit
254 Motion vector reconstruction unit
255 Spatially-neighboring motion vector buffer
256 Temporally-neighboring motion vector buffer
261 Field determination unit
262 Motion vector shifting unit

1. An image processing device comprising:
a predicted motion vector generation unit configured to generate a temporally-predicted motion vector of predicted motion vectors to be used in decoding a motion vector of a current region in an image of an interlaced signal, by using a motion vector of a temporally-adjacent region that is located temporally adjacent to the current region;
a parity adjustment unit configured to perform shift adjustment on a vertical component of the temporally-predicted motion vector generated by the predicted motion vector generation unit, in accordance with a parity relation between the current region and a current reference region to be referenced by the motion vector of the current region, and a parity relation between the temporally-adjacent region and an adjacent reference region to be referenced by the motion vector of the temporally-adjacent region; and
a motion vector decoding unit configured to decode the motion vector of the current region by using the temporally-predicted motion vector having the vertical component subjected to the shift adjustment by the parity adjustment unit.

2. The image processing device according to claim 1, wherein, when the phase shifting indicated by the parity relation between the current region and the current reference region differs from the phase shifting indicated by the parity relation between the temporally-adjacent region and the adjacent reference region, the parity adjustment unit performs shift adjustment on the vertical component of the temporally-predicted motion vector generated by the predicted motion vector generation unit.

3. The image processing device according to claim 2, wherein, when the phase shifting indicated by the parity relation between the current region and the current reference region is the opposite of the phase shifting indicated by the parity relation between the temporally-adjacent region and the adjacent reference region, the parity adjustment unit performs 1 or −1 shift adjustment on the vertical component of the temporally-predicted motion vector generated by the predicted motion vector generation unit.

4. The image processing device according to claim 3, wherein, when the parity relation between the current region and the current reference region is “BT” while the parity relation between the temporally-adjacent region and the adjacent reference region is “TB”, the parity adjustment unit performs 1 shift adjustment on the vertical component of the temporally-predicted motion vector generated by the predicted motion vector generation unit.

5. The image processing device according to claim 2, wherein, when only one of the parity relation between the current region and the current reference region, and the parity relation between the temporally-adjacent region and the adjacent reference region indicates phase shifting, and the other one of the parity relations indicates no phase shifting, the parity adjustment unit performs ½ or −½ shift adjustment on the vertical component of the temporally-predicted motion vector generated by the predicted motion vector generation unit.

6. The image processing device according to claim 5, wherein, when the parity relation between the current region and the current reference region is “TT” while the parity relation between the temporally-adjacent region and the adjacent reference region is “BT”, the parity adjustment unit performs ½ shift adjustment on the vertical component of the temporally-predicted motion vector generated by the predicted motion vector generation unit.

7. The image processing device according to claim 2, wherein the motion vector decoding unit decodes the motion vector of the current region by using the temporally-predicted motion vector having the vertical component subjected to the shift adjustment by the parity adjustment unit based on Advanced Motion Vector Prediction.

8. The image processing device according to claim 2, wherein the motion vector decoding unit decodes the motion vector of the current region by using the temporally-predicted motion vector having the vertical component subjected to the shift adjustment by the parity adjustment unit based on Motion Partition Merging.

9. An image processing method comprising:
generating a temporally-predicted motion vector of predicted motion vectors to be used in decoding a motion vector of a current region in an image of an interlaced signal, by using a motion vector of a temporally-adjacent region that is located temporally adjacent to the current region;
performing shift adjustment on a vertical component of the generated temporally-predicted motion vector, in accordance with a parity relation between the current region and a current reference region to be referenced by the motion vector of the current region, and a parity relation between the temporally-adjacent region and an adjacent reference region to be referenced by the motion vector of the temporally-adjacent region; and
decoding the motion vector of the current region by using the temporally-predicted motion vector having the vertical component subjected to the shift adjustment,
an image processing device generating the temporally-predicted motion vector, performing the shift adjustment, and decoding the motion vector of the current region.

10. An image processing device comprising:
a predicted motion vector generation unit configured to generate a temporally-predicted motion vector of predicted motion vectors to be used in encoding a motion vector of a current region in an image of an interlaced signal, by using a motion vector of a temporally-adjacent region that is located temporally adjacent to the current region;
a parity adjustment unit configured to perform shift adjustment on a vertical component of the temporally-predicted motion vector generated by the predicted motion vector generation unit, in accordance with a parity relation between the current region and a current reference region to be referenced by the motion vector of the current region, and a parity relation between the temporally-adjacent region and an adjacent reference region to be referenced by the motion vector of the temporally-adjacent region; and
a motion vector encoding unit configured to encode the motion vector of the current region by using the temporally-predicted motion vector having the vertical component subjected to the shift adjustment by the parity adjustment unit.

11. The image processing device according to claim 10, wherein, when the phase shifting indicated by the parity relation between the current region and the current reference region differs from the phase shifting indicated by the parity relation between the temporally-adjacent region and the adjacent reference region, the parity adjustment unit performs shift adjustment on the vertical component of the temporally-predicted motion vector generated by the predicted motion vector generation unit.

12. The image processing device according to claim 11, wherein, when the phase shifting indicated by the parity relation between the current region and the current reference region is the opposite of the phase shifting indicated by the parity relation between the temporally-adjacent region and the adjacent reference region, the parity adjustment unit performs 1 or −1 shift adjustment on the vertical component of the temporally-predicted motion vector generated by the predicted motion vector generation unit.

13. The image processing device according to claim 12, wherein, when the parity relation between the current region and the current reference region is “BT” while the parity relation between the temporally-adjacent region and the adjacent reference region is “TB”, the parity adjustment unit performs 1 shift adjustment on the vertical component of the temporally-predicted motion vector generated by the predicted motion vector generation unit.

14. The image processing device according to claim 11, wherein, when only one of the parity relation between the current region and the current reference region, and the parity relation between the temporally-adjacent region and the adjacent reference region indicates phase shifting, and the other one of the parity relations indicates no phase shifting, the parity adjustment unit performs ½ or −½ shift adjustment on the vertical component of the temporally-predicted motion vector generated by the predicted motion vector generation unit.

15. The image processing device according to claim 14, wherein, when the parity relation between the current region and the current reference region is “TT” while the parity relation between the temporally-adjacent region and the adjacent reference region is “BT”, the parity adjustment unit performs ½ shift adjustment on the vertical component of the temporally-predicted motion vector generated by the predicted motion vector generation unit.

16. The image processing device according to claim 11, wherein the motion vector encoding unit encodes the motion vector of the current region by using the temporally-predicted motion vector having the vertical component subjected to the shift adjustment by the parity adjustment unit based on Advanced Motion Vector Prediction.

17. The image processing device according to claim 11, wherein the motion vector encoding unit encodes the motion vector of the current region by using the temporally-predicted motion vector having the vertical component subjected to the shift adjustment by the parity adjustment unit based on Motion Partition Merging.

18. An image processing method comprising:
generating a temporally-predicted motion vector of predicted motion vectors to be used in encoding a motion vector of a current region in an image of an interlaced signal, by using a motion vector of a temporally-adjacent region that is located temporally adjacent to the current region;
performing shift adjustment on a vertical component of the generated temporally-predicted motion vector, in accordance with a parity relation between the current region and a current reference region to be referenced by the motion vector of the current region, and a parity relation between the temporally-adjacent region and an adjacent reference region to be referenced by the motion vector of the temporally-adjacent region; and
encoding the motion vector of the current region by using the temporally-predicted motion vector having the vertical component subjected to the shift adjustment,
an image processing device generating the temporally-predicted motion vector, performing the shift adjustment, and encoding the motion vector of the current region.
